(19) United States
(12) Patent Application Publication
(10) Pub. No.: US 2023/0166892 A1
(43) Pub. Date: Jun. 1, 2023

(54) Child-Resistant Container

(71) Applicants: Matthew IORIO, Foxboro, MA (US); EIGHTY EIGHT PHARMA, INC., Mansfield, MA (US)

(72) Inventor: Matthew IORIO, Foxboro, MA (US)

(21) Appl. No.: 17/997,277

(22) PCT Filed: Apr. 28, 2021
(86) PCT No.: PCT/US2021/029617

§ 371 Date: Oct. 27, 2022

Related U.S. Application Data
(60) Provisional application No. 63/080,903, filed on Sep. 21, 2020.
(60) Provisional application No. 63/016,491, filed on Apr. 28, 2020.

(51) Int. Cl. B65D 50/04; A61J 1/03

(52) U.S. Cl. CPC B65D 50/04; A61J 1/03; B65D 2215/02

(57) ABSTRACT

The present disclosure relates to child-resistant devices and methods thereof. More particularly, the disclosure elates to devices for restricting access to a container by using a physical deterrent, and methods thereof.

### FIELD OF THE INVENTION

The present disclosure generally relates to a child-resistant container and methods for use thereof. More particularly, the disclosure relates to a container with a child-resistant lid or top. The present disclosure also relates to methods of using the child-resistant container or accessing the contents or inside of the child-resistant container.

### BACKGROUND OF THE INVENTION

Child resistant containers became mandatory on a number of household substances and most prescription drugs after the enactment of the Poison Prevention Packaging Act in 1970. See 15 U.S.C. §§ 1471 et seq. In 1972, the Consumer Products Safety Act extended the government's authority to prohibit the marketing of unsafe children's products. See 15 U.S.C. §§ 2051-2089. Child-resistant packaging as defined by statute must be “designed or constructed to be significantly difficult for children under 5 [five] years of age to open or obtain a toxic or harmful amount of the substance contained therein within a reasonable time, and not difficult for adults to use properly”. 15 U.S.C. § 1471(4).

Despite these laws, more than 10,000 children are taken to emergency rooms each year for injuries related to airway obstructions. Jenco M. American Academy of Pediatrics, 2019; Orsagh-Yentis D, et al. Pediatrics. Apr. 12, 2019, https://doi.org/10.1542/peds.2018-1988. Coins are a very common choking hazard (id.) and there are no child resistant containers to hold coins.

Furthermore, there are critical design flaws in removable child resistant caps. The most serious flaw in removable child resistant caps is that once the cap is removed, it provides no protection from ingestion of the enclosed substance. Once a cap is removed, if it is not replaced securely, all of the contents of the package can be easily removed or dumped out. A study that examined the change in packaging of levothyroxine from a bottle to a blister pack showed a reduction in accidental exposures from 12.1 per month to 5.8 per month. See van Riel, A. J. et al. Clinical Toxicology, June 2017.

A second serious flaw in threaded child resistant caps is that they require a strong and dexterous wrist movement to repeatedly grip and spin a cap. Many people, particularly elderly people, individuals with muscular or joint disorders, may not be able to perform the movement that is required to remove a threaded child resistant cap.

There remains a need for a child-resistant cap and associated containers that reduce the risk of injury to children related to swallowing unsafe objects or chemicals, while enabling elderly people and those with underlying muscular or joint conditions or disorders to open or access the contents of containers with child-resistant caps.

### SUMMARY OF THE INVENTION

It is against the above background that the disclosure provides certain advantages and advancements over the prior art. Although the disclosure herein is not limited to specific advantages or functionality, the invention disclosed herein provides devices and methods for restricting access to a container by using a physical deterrent.

In one aspect, the disclosure includes a device for a child-resistant container, the device comprising: (1) a housing comprising one or more compartments and an opening to a tunnel in the center of the housing; and (2) a child-resistant lid comprising: (a) a lower lid comprising a tubular projection in the center, one or more raised ridges or teeth on the top surface of the lower lid, and an access port for accessing said one or more compartments; and (b) an upper lid comprising: a tubular projection in the center, one or more recesses, grooves, slots or depressions on the bottom surface of the upper lid, and an access port for accessing said one or more compartments.

In another aspect, the disclosure includes a two-piece child-resistant lid comprising: (1) a lower lid comprising: (a) a tubular projection in the center, (b) one or more raised ridges or teeth on the top surface of the lower lid, and (c) an access port for accessing one or more compartments in a housing; and (2) an upper lid comprising: (a) a tubular projection in the center, wherein the tubular projection of the upper lid fits inside and attaches to the tubular projection of the lower lid, (b) one or more recesses, grooves, slots or depressions on the bottom surface of the upper lid, and (c) an access port for accessing said one or more compartments, wherein the access port of the upper lid is capable of lining up with the access port of the lower lid, and wherein said one or more compartments may be accessed by depressing the top of the upper lid of the child-resistant lid and rotating the cap clockwise or counter-clockwise.

In some embodiments, the tubular projection of the lower lid and the tubular projection of the upper lid further comprise a collar.

In another aspect, the disclosure includes a method of accessing a child-restraint container, the method comprising: providing: (1) a housing comprising: (a) one or more compartments, and (b) an opening to a tunnel in the center of the housing; (2) a child-resistant lid comprising: (a) a lower lid comprising a tubular projection, wherein the tubular projection is inserted into and attached to the tunnel within the center of the housing, one or more raised ridges or teeth on the top surface of the lower lid, and an access port for accessing said one or more compartments; (b) an upper lid comprising: a tubular projection in the center, wherein the tubular projection of the upper lid is inserted into and attached to the tubular projection of the lower lid; one or more recesses, grooves, slots, depressions or channels on the bottom surface of the lower lid, and an access port for accessing said one or more compartments, lining up the access port of the upper lid with the access port of the lower lid; depressing the top of the upper lid of the child-resistant lid; and turning the lid clockwise or counter-clockwise until the access port is lined up with one or more of the compartments.

In another aspect, the disclosure includes a device for a child-resistant container, the device comprising: (1) a housing comprising one or more compartments and an opening to a tunnel in the center of the housing; and (2) a child-resistant lid comprising: (a) a lower lid comprising a tubular projection in the center, one or more recesses, grooves, slots, depressions or channels on the top surface of the lower lid, and an access port for accessing said one or more compartments, and (b) an upper lid comprising: a tubular projection in the center, one or more raised ridges or teeth on the bottom surface of the upper lid, and an access port for accessing said one or more compartments.

In another aspect, the disclosure includes a two-piece child-resistant lid comprising: (1) a lower lid comprising: (a) a tubular projection in the center, (b) one or more recesses, grooves, slots, depressions or channels on the top surface of the lower lid, and (c) an access port for accessing one or more compartments in a housing: and (2) an upper lid comprising: (a) a tubular projection in the center, wherein the tubular projection of the upper lid fits inside and attaches to the tubular projection of the lower lid, (b) one or more raised ridges or teeth on the bottom surface of the upper lid, and (c) an access port for accessing said one or more compartments, wherein the access port of the upper lid is capable of lining up with the access port of the lower lid, and wherein said one or more compartments may be accessed by depressing the top of the upper lid of the child-resistant lid and rotating the cap clockwise or counter-clockwise.

In some embodiments, the tubular projection of the lower lid and the tubular projection of the upper lid further comprise a collar.

In another aspect, the disclosure includes a method of accessing a child-restraint container, the method comprising: providing: (1) a housing comprising: (a) one or more compartments, and (b) an opening to a tunnel in the center of the housing; (2) a child-resistant lid comprising: (a) a lower lid comprising a tubular projection, wherein the tubular projection is inserted into and attached to the tunnel within the center of the housing, one or more recesses, grooves, slots, depressions or channels on the top surface of the lower lid, and an access port for accessing said one or more compartments; (b) an upper lid comprising: a tubular projection in the center, wherein the tubular projection of the upper lid is inserted into and attached to the tubular projection of the lower lid, one or more raised ridges or teeth on the bottom surface of the upper lid, and an access port for accessing said one or more compartments; lining up the access port of the upper lid with the access port of the lower lid; depressing the top of the upper lid of the child-resistant lid; and rotating the lid clockwise or counter-clockwise until the access port is lined up with one or more of the compartments.

In another aspect, the disclosure includes a method of filling one or more compartments of the child-resistant container, the method comprising: pouring a solid product onto a sticker or fill assister affixed to the center of the housing that covers the hollow or tunnel, pushing or placing the proper amount of product into each said compartment, removing the sticker or fill assister from the center of the housing, assembling the two-piece child-resistant lid, and attaching said lid to the housing.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows an embodiment of a child-resistant container with a child-resistant lid in accordance with illustrative embodiments of the invention.

FIG. 2 schematically shows an alternative view of the child-resistant container with the child-resistant lid in accordance with illustrative embodiments of the invention as shown in FIG. 1.

FIG. 3 schematically shows an alternative view of the child-resistant container without the child-resistant lid in accordance with illustrative embodiments of the invention as shown in FIGS. 1 and 2.

FIG. 4 schematically shows an alternative view of the two-piece child-resistant lid in accordance with illustrative embodiments of the invention as shown in FIGS. 1 and 2.

FIG. 5 schematically shows alternative views A and B of the child-resistant lid in accordance with illustrative embodiments of the invention as shown in FIGS. 1, 2 and 4.

FIG. 6 schematically shows an alternative embodiment of the child-resistant container with the child-resistant lid in accordance with illustrative embodiments of the invention.

FIG. 7 schematically shows another alternative embodiment of the child-resistant container with the child-resistant lid in accordance with illustrative embodiments of the invention.

FIG. 8 schematically shows an alternative view of the child-resistant container with the child-resistant lid in accordance with illustrative embodiments of the invention as shown in FIG. 7.

FIG. 9 schematically shows an alternative sectional view of the child-resistant container with the child-resistant lid attached in accordance with illustrative embodiments of the invention.

FIG. 10 schematically shows an alternative embodiment of the child-resistant container with the child-resistant lid in accordance with illustrative embodiments of the invention.

FIG. 11 schematically shows alternative views A and B of the child-resistant container with the child-resistant lid in accordance with illustrative embodiments of the invention as shown in FIG. 10.

FIG. 12 schematically shows an embodiment of the child-resistant container with the child-resistant lid in accordance with illustrative embodiments of the invention.

FIG. 13 schematically shows an alternative view of the child-resistant container with the child-resistant lid in accordance with illustrative embodiments of the invention as shown in FIG. 12.

FIG. 14 schematically shows alternative views A and B of the two-piece child-resistant lid in accordance with illustrative embodiments of the invention as shown in FIGS. 12 and 13.

FIG. 15 schematically shows an embodiment of the child-resistant container with the child-resistant lid in accordance with illustrative embodiments of the invention.

FIG. 16 schematically shows an alternative view of the child-resistant container with the child-resistant lid in accordance with illustrative embodiments of the invention as shown in FIG. 15.

FIG. 17 schematically shows alternative views A and B of the housing and the two-piece child-resistant lid in accordance with illustrative embodiments of the invention as shown in FIGS. 15 and 16.

FIG. 18 schematically shows an embodiment of the child-resistant container with the child-resistant lid in accordance with illustrative embodiments of the invention.

FIG. 19 schematically shows an alternative view of the child-resistant container with the child-resistant lid in accordance with illustrative embodiments of the invention as shown in FIG. 18.

FIG. 20 schematically shows alternative views A and B of the tunnel in the center of the housing and the tubular projection on the lower lid of the child-resistant lid in accordance with illustrative embodiments of the invention as shown in FIGS. 18 and 19.

FIG. 21 schematically shows an embodiment of the child-resistant container with the child-resistant lid in accordance with illustrative embodiments of the invention.

FIG. 22 schematically shows an alternative view of the child-resistant container with the child-resistant lid in accordance with illustrative embodiments of the invention as shown in FIG. 21.

FIG. 23 schematically shows alternative views of the tunnel in the center of the housing and the spring-like flaps on the lower lid of the child-resistant lid in accordance with illustrative embodiments of the invention as shown in FIGS. 21 and 22.

FIG. 24 schematically shows an alternative view of the child-resistant container with the child-resistant lid in accordance with illustrative embodiments of the invention as shown in FIGS. 21-23.

FIG. 25 schematically shows an alternative view of the child-resistant container with the child-resistant lid in accordance with illustrative embodiments of the invention as shown in FIGS. 21-24.

FIG. 26 schematically shows alternative views of the child-resistant container with the child-resistant lid in accordance with illustrative embodiments of the invention as shown in FIGS. 21-25.

### DETAILED DESCRIPTION OF THE INVENTION

Before the disclosed devices and methods are described in detail, it is to be understood that the aspects described herein are not limited to specific embodiments or configurations and, as such, may vary. It is also to be understood that the terminology used herein is for the purpose of describing particular aspects only and, unless specifically defined herein, is not intended to be limiting.

It is also to be understood that, unless clearly indicated otherwise by the context, embodiments disclosed for one aspect or embodiment of the disclosure may be used in other aspects or embodiments as well, and/or in combination with embodiments disclosed in the same or other aspects of the disclosure. Thus, the disclosure is intended to include such combinations, even where such combinations have not been explicitly delineated.

### Definitions

Throughout the specification. unless the context requires otherwise, the word “comprise” and “include” and variations (e.g., “comprises,” “comprising,” “includes,” “including”) will be understood to imply the inclusion of a stated component, feature, element, or step or group of components, features, elements or steps but not the exclusion of any other integer or step or group of integers or steps.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

As used in the specification and the appended claims, the singular forms “a,” “an” and “the” include plural referents unless the context clearly dictates otherwise.

Values may be expressed herein as approximations by use of the antecedent “about,” and it is understood that the particular value forms an aspect. Similarly, ranges may be expressed herein as from “about” one particular value, and/or to “about” another particular value. When such range is expressed, another aspect includes from the one particular value and/or to the other particular value. It will be further understood that the endpoints of each of the ranges are significant both in relation to the other endpoint, and independently of the other endpoint.

As used herein, the terms “rotate,” “rotated” or “rotation” include turning, twisting, sliding, pivoting, spinning, opening or closing of, for example, a lid, cap, top, hinge, flap, shutter, etc.

As used herein, the term “tubular projection” refers to an elongated component or elongated components of any appropriate diameter or length. A tubular projection may be segmented or non-continuous in its circumference, and/or may include ridges or striations of any appropriate size or depth. A tubular projection or protrusion may include a collar or an open, mushroom-type cap or end.

As used herein, the term “striated,” “striation” or “striations” includes rows, lines, ridges, recesses or grooves of any appropriate length, width or depth, which may be used to attach, secure or engage components to, or in contact with, one another.

As used herein, the term “compartment” refers to a space, cavity, chamber, or hollow within the housing of the child-resistant container. The compartment may be of any appropriate size, including length, width, shape, or depth to fit within the housing of the child-resistant container.

As used herein, the term “child-resistant lid,” refers to a covering for the disclosed housing of the child-resistant container, and is interchangeably referred to as a top, cap, or cover. In disclosed embodiments, a lid containing the disclosed child-resistant features is non-removable.

As used herein, the term “removable lid” refers to a covering that does not include the disclosed child-resistant features, and is interchangeably referred to as a removable top, cap or cover. Removable lids as disclosed herein are capable of including one or more physical deterrents, such as a lock or other physical deterrent to prevent improper access to the contents of the container.

As used herein, the terms “circular tension,” “helical tension,” “circular compression,” or “helical compression” are interchangeable and refer to the tension necessary to prevent the lower lid from rotating around the center of the housing when the upper lid is not properly depressed into the lower lid, but not so firm as to prevent the lower lid from rotating when the upper lid is properly depressed into the lower lid.

As used herein, the term “knob” refers to a handle, grip or dial used to assist in rotating the child-resistant lid.

### DESCRIPTION OF ILLUSTRATIVE EMBODIMENTS

In illustrative embodiments the device deters or prevents unauthorized or accidental access to a container and the contents of the container. The device includes a physical barrier that prevents or deters access to the container. The device may include a locking mechanism coupled to a physical barrier that prevents or deters access to the container and its contents by unauthorized users.

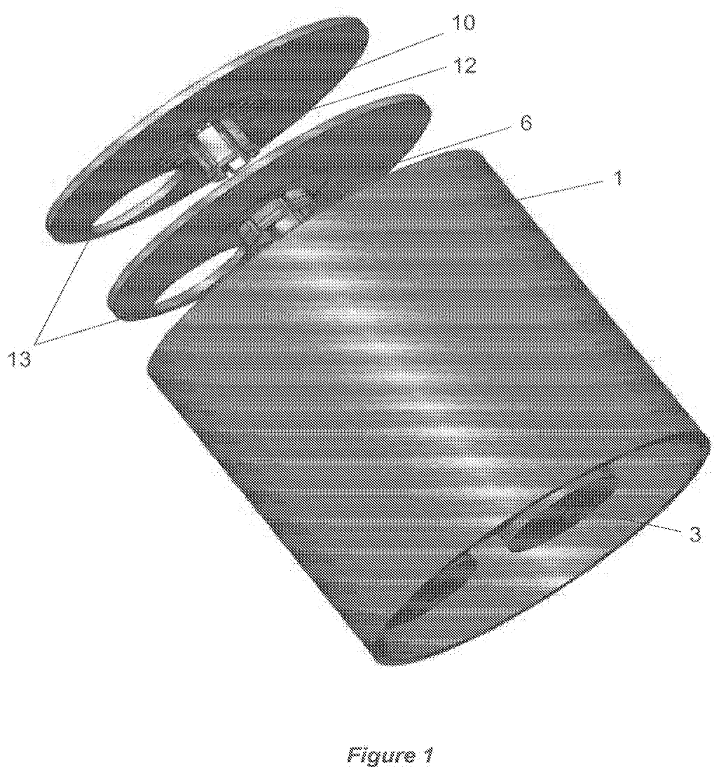

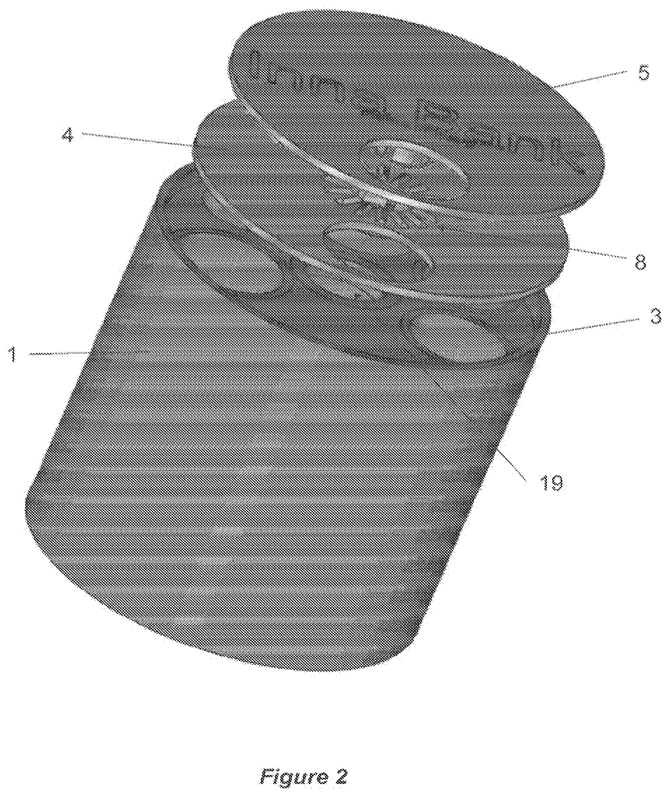

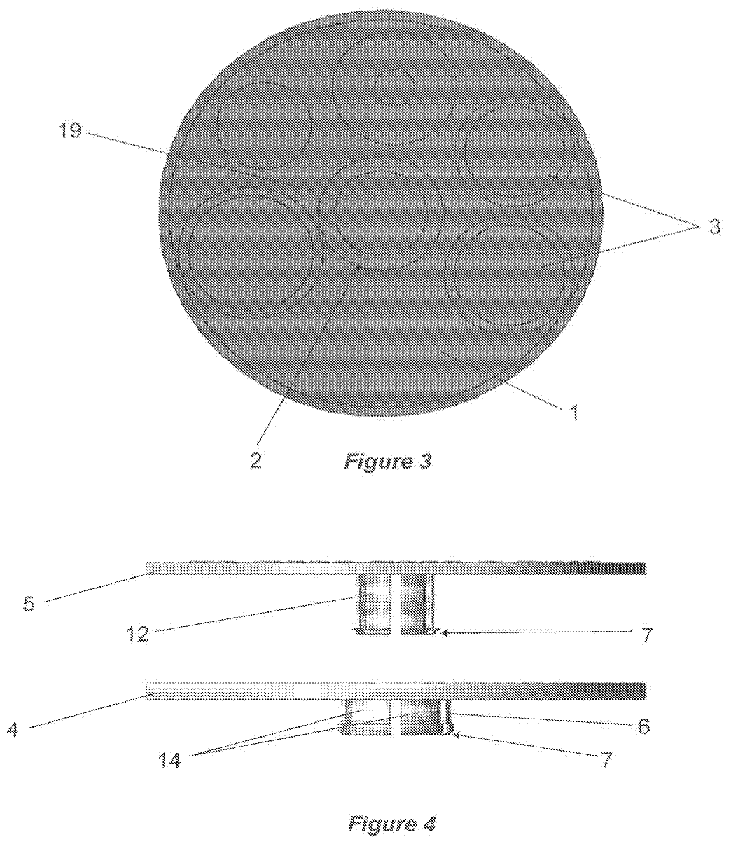

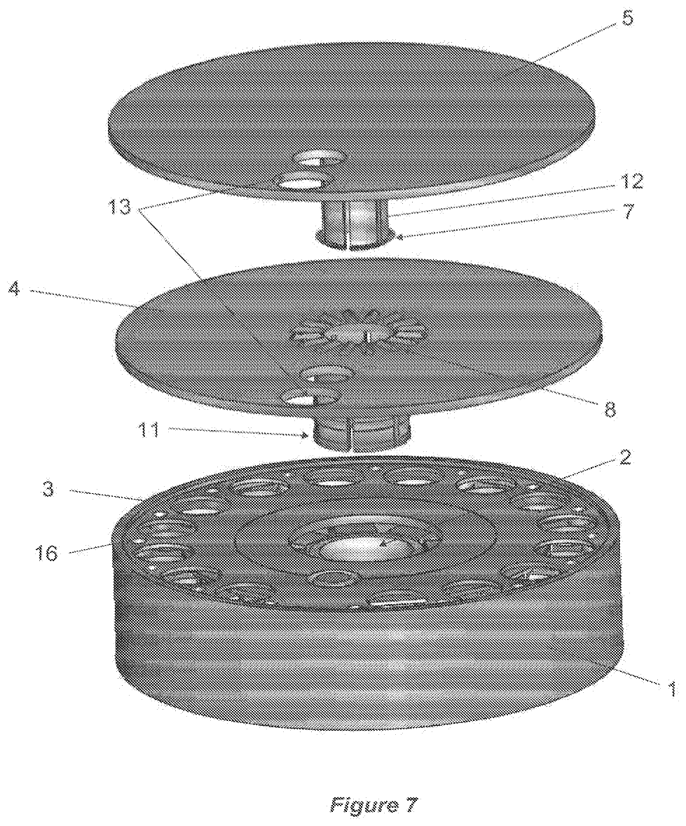

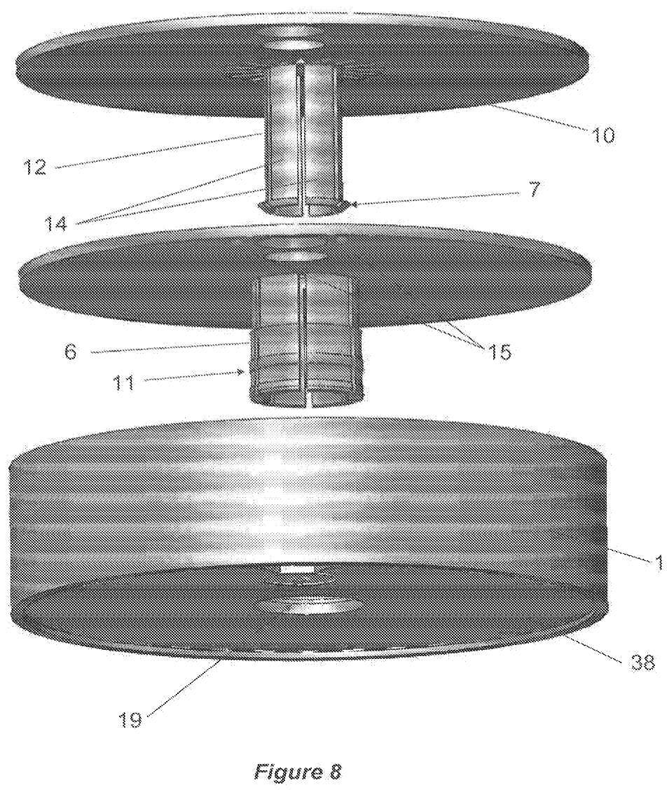

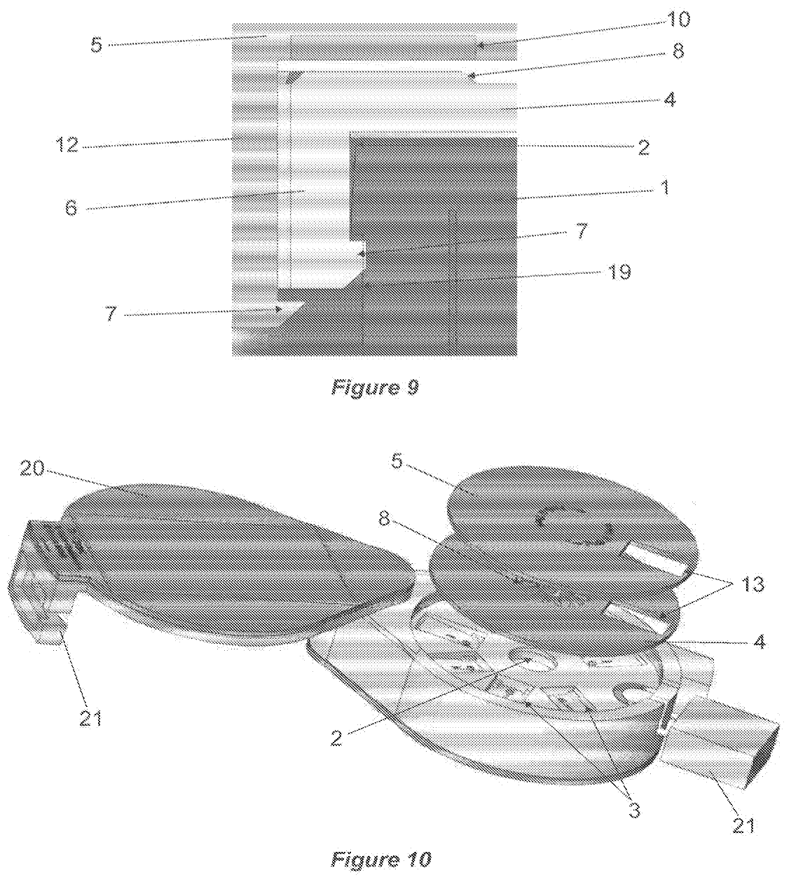

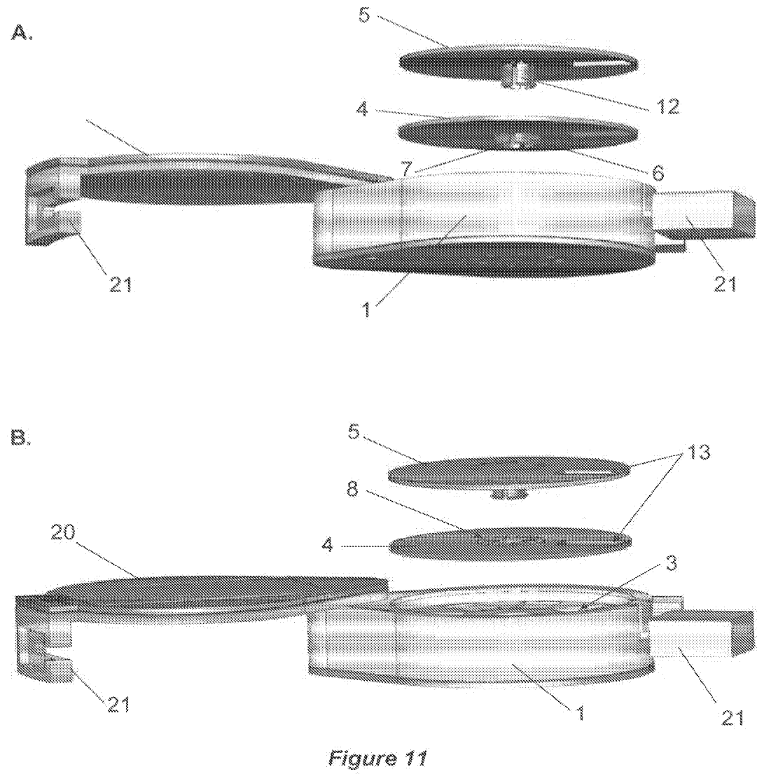

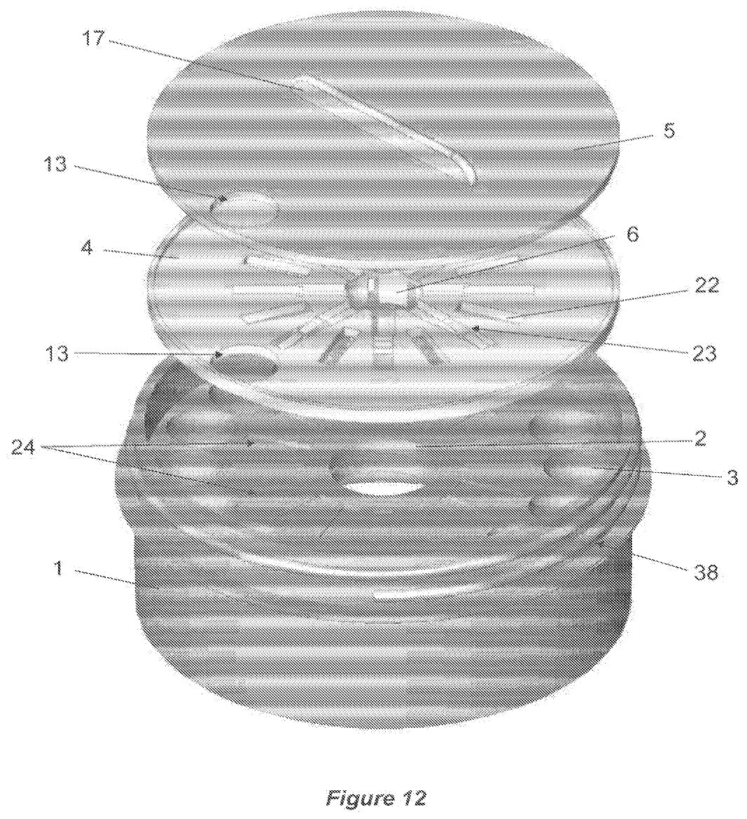

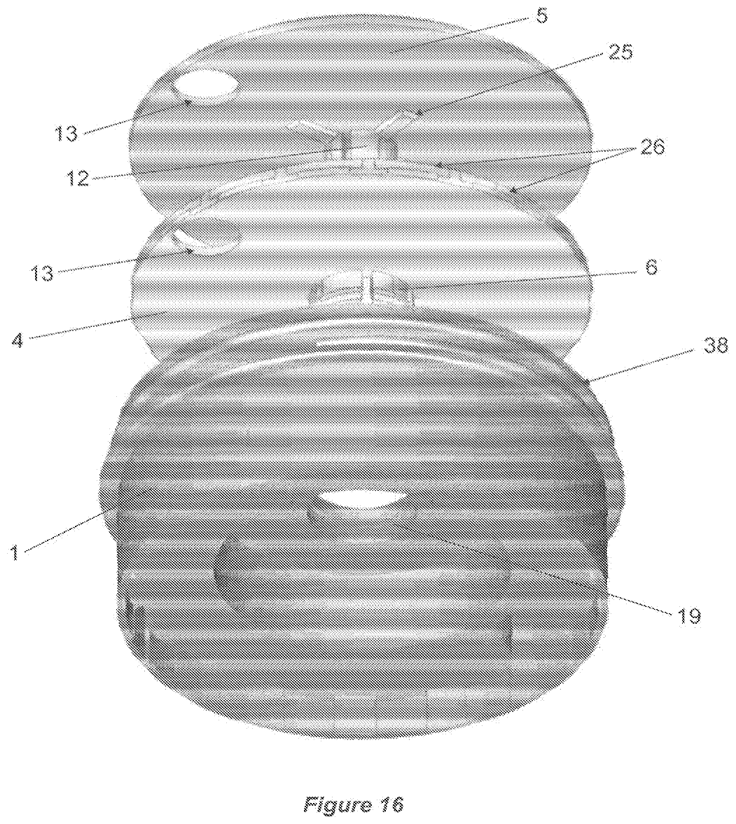

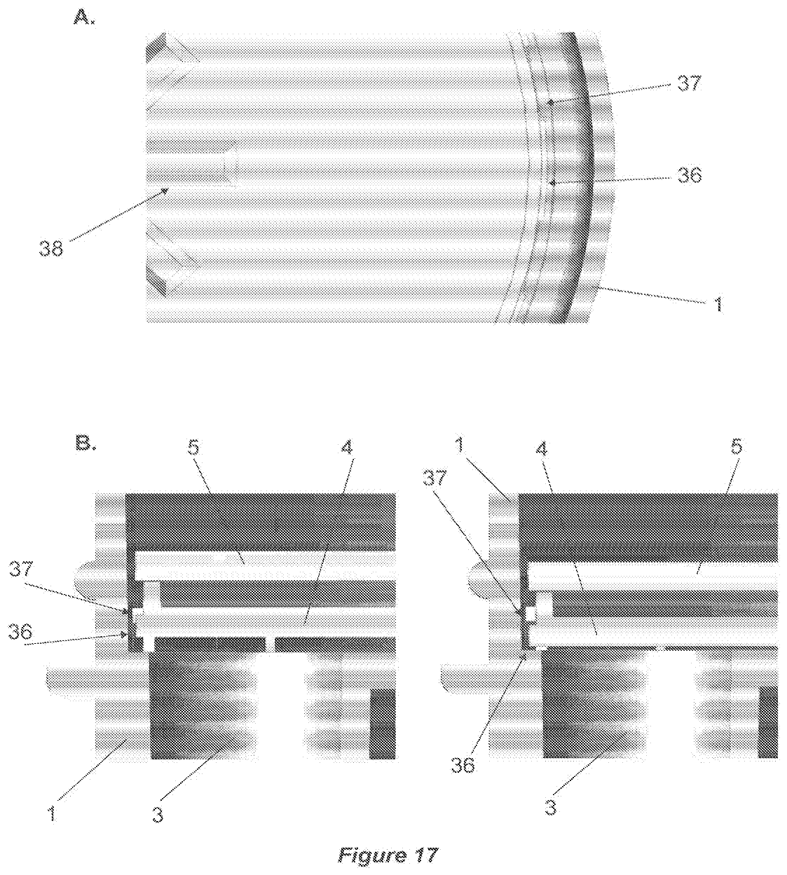

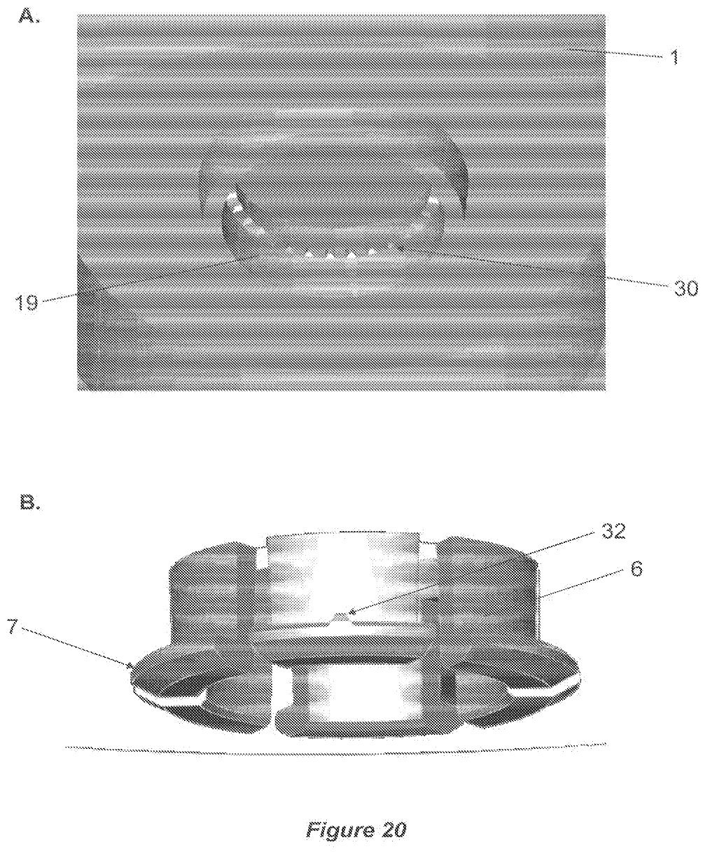

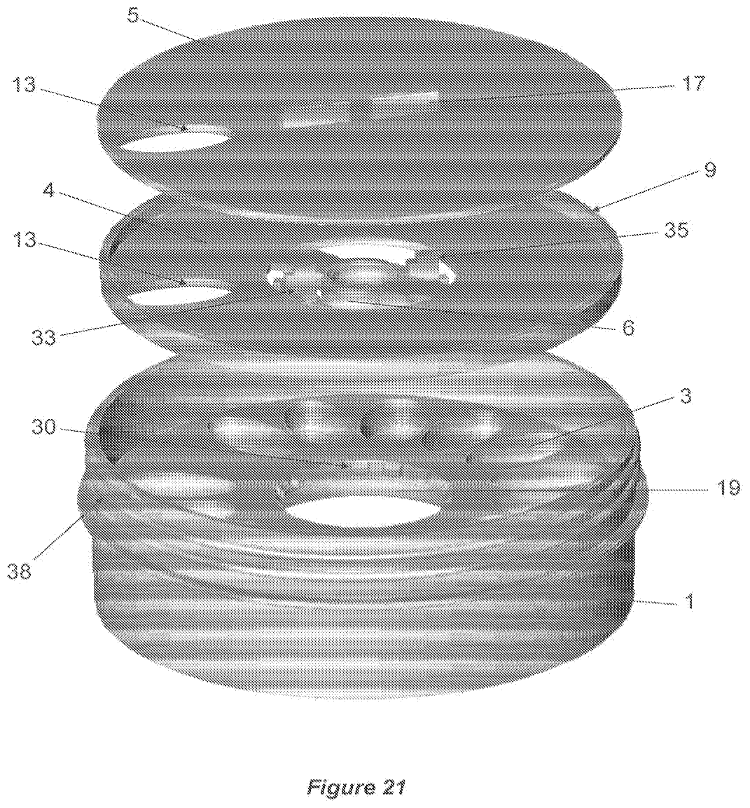

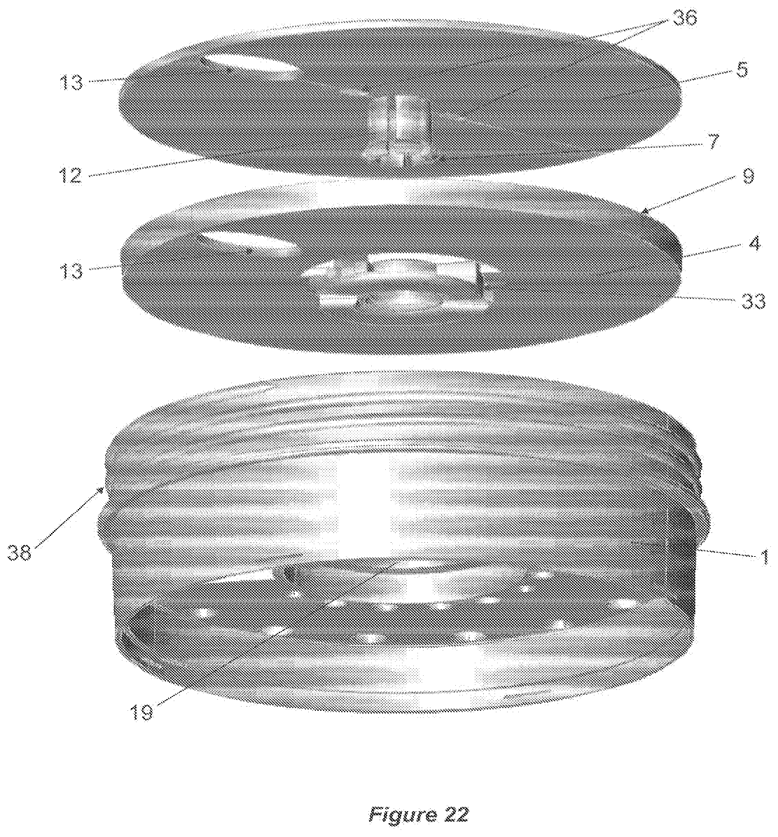

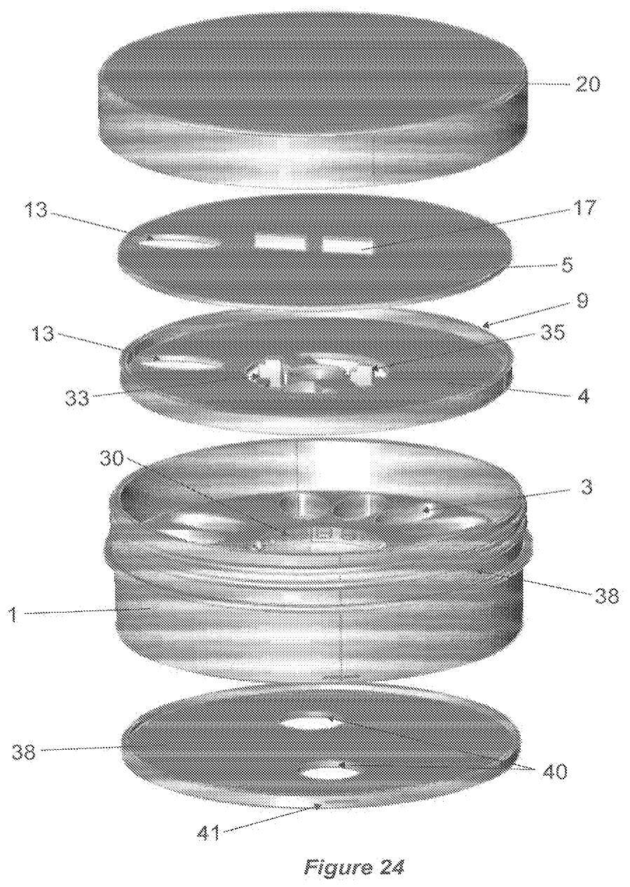

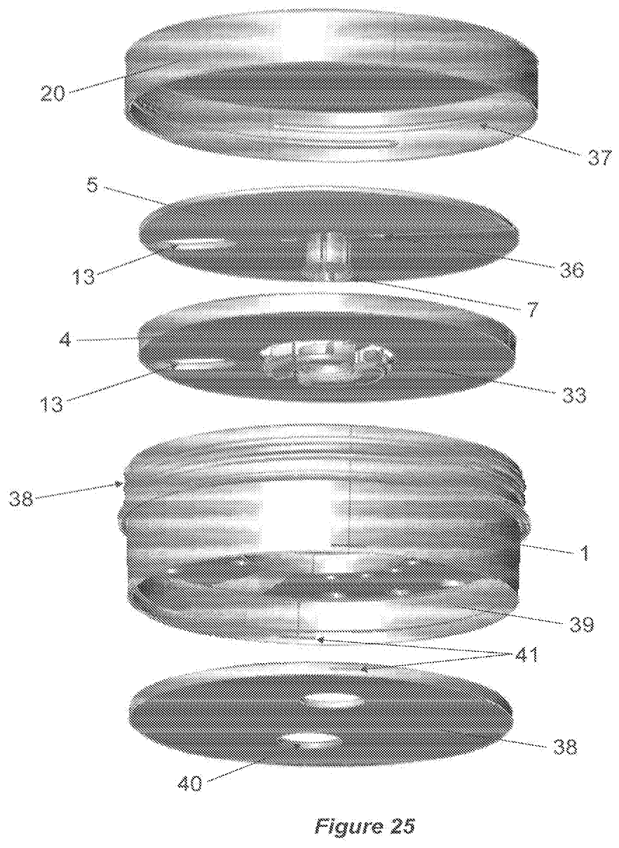

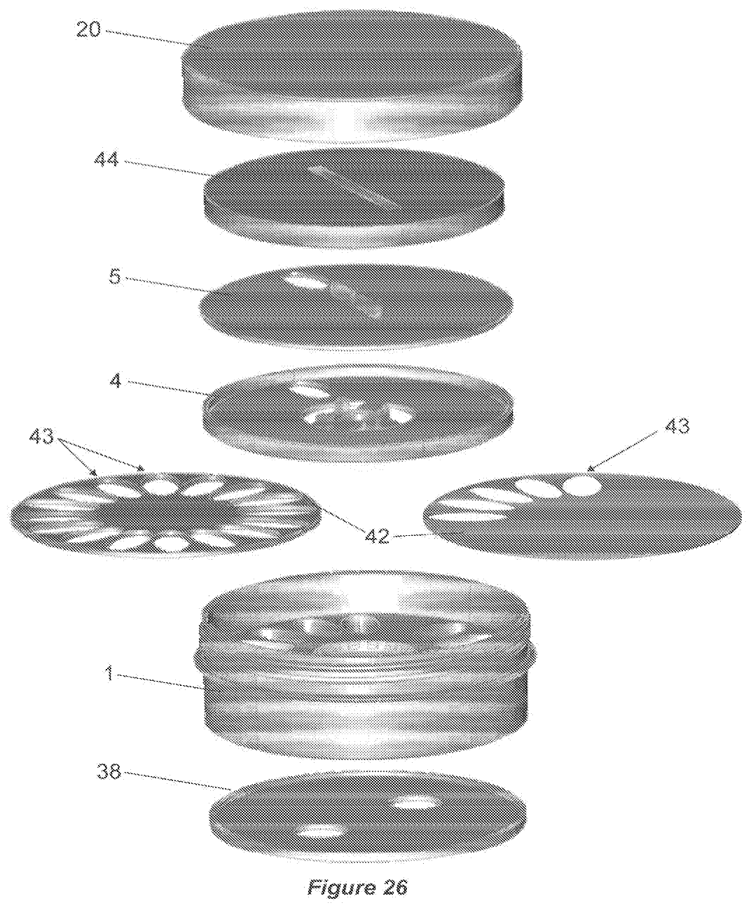

The housing (1) of the device may be of any suitable shape and size capable of incorporating the child-resistant features disclosed herein. In illustrative embodiments, as shown in FIGS. 1, 2, 6-8, 12, 13, 16, 17, 21, 22, 24-26, the child-resistant container includes a cylindrical housing (1) with a cylindrical hollow or tunnel (19) in the center (2) of the housing (1) and one or more compartments (3). In other illustrative embodiments, the housing (1) of the child-resistant container is teardrop shaped, oblong, or irregularly shaped, as shown in FIGS. 10 and 11. The one or more compartments (3) are not limited to a particular size or shape, but may be of any size or shape necessary to house a desired object or objects. In some illustrative embodiments, the one or more compartments (3) are cylindrical in various sizes, as shown in FIGS. 2, 3, 6, 7, 12, 16 and 20. In other illustrative embodiments, the one or more compartments (3) are square or rectangular, as shown in FIGS. 10 and 11. In still other illustrative embodiments, the one or more compartments (3) are oblong or oval, as shown in FIGS. 21 and 24. In some illustrative embodiments, as shown in FIGS. 8 and 24-26, the child-resistant container includes a separate compartment (39) located on the bottom of the container, and may include a removable cap (38).

In some embodiments, the removable cap (38) may include one or more holes (40) to assist in removal of the cap. In some illustrative embodiments, the removeable cap (38) includes one or more raised ridges, teeth or protrusions (41) located around the circumference of the removable cap (38) that interact with one or more raised ridges, teeth or protrusions (41) on the interior circumference of the housing (1). The one or more raised ridges, teeth or protrusions (41) assist in keeping the removable cap (38) affixed to the bottom of the housing (1) until removal is attempted, as discussed above.

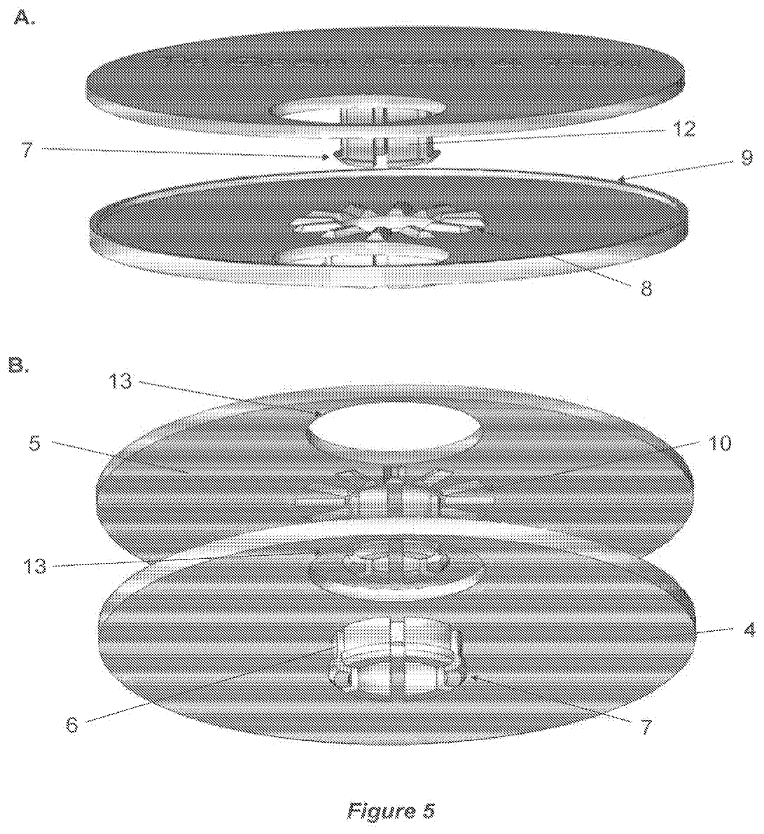

The child-resistant container also includes a two-piece child-resistant lid with a lower lid (4) and an upper lid (5), as shown in FIGS. 1, 2, 4-8, 10-13, 15-17, 20-22, and 24-26. The lower lid (4) includes a tubular projection (6) in the center which inserts into and attaches to the hollow or tunnel (19) in the center (2) of the housing (1). In some embodiments, the tubular projection (6) is segmented or non-continuous (14) in its circumference. The outer surface of the tubular projection (6) on the lower lid (4) of the child-resistant lid includes a collar (7) around its circumference such that the lower lid (4) is affixed to the hollow or tunnel (19) in the center (2) of the housing (1) with sufficient compression tension such that the lower lid (4) does not normally rotate around the housing (I). In some embodiments, the outer surface of the tubular projection (6) includes one or more striations (11) around its circumference which assist in affixing the lower lid (4) to the hollow or tunnel (19) in the center (2) of the housing (1), as detailed above. In some embodiments, as shown in FIGS. 2, 5-7, 10 and 11, the top surface of the lower lid (4) further includes raised ridges or teeth (8) arrayed around the opening for the tubular projection (6). In certain embodiments, the raised ridges or teeth (8) arrayed around the center of the opening for the tubular projection (6) are 0.5 mm in height. In some embodiments, the lower lid (4) includes a lip (9) around its circumference. In some embodiments, the lip (9) around the circumference of the lower lid (4) is 1.0 mm in height.

The upper lid (5) of the child-resistant lid also includes a tubular projection (12) in the center which is inserted into and attaches to the tubular projection (6) of the lower lid (4). In some embodiments, the tubular projection (12) is segmented or non-continuous (14) in its circumference. In some embodiments, the outer surface of the tubular projection (12) on the upper lid (5) of the child-resistant lid includes a collar (7) around its circumference. In some embodiments, as shown in FIGS. 1, 5 and 8, the bottom surface of the upper lid (5) of the child-resistant lid further includes recesses, grooves or slots (10) arrayed around the base of the tubular projection (12) which are capable of contacting or fitting into the raised ridges or teeth (8) on the top surface of the lower lid (4). In some embodiments, the bottom surface of the lower lid (4) further includes one or more raised protrusions (15) capable of interacting with and fitting into recesses (16) on the housing (1), the recesses (16) located on either side of a compartment (3).

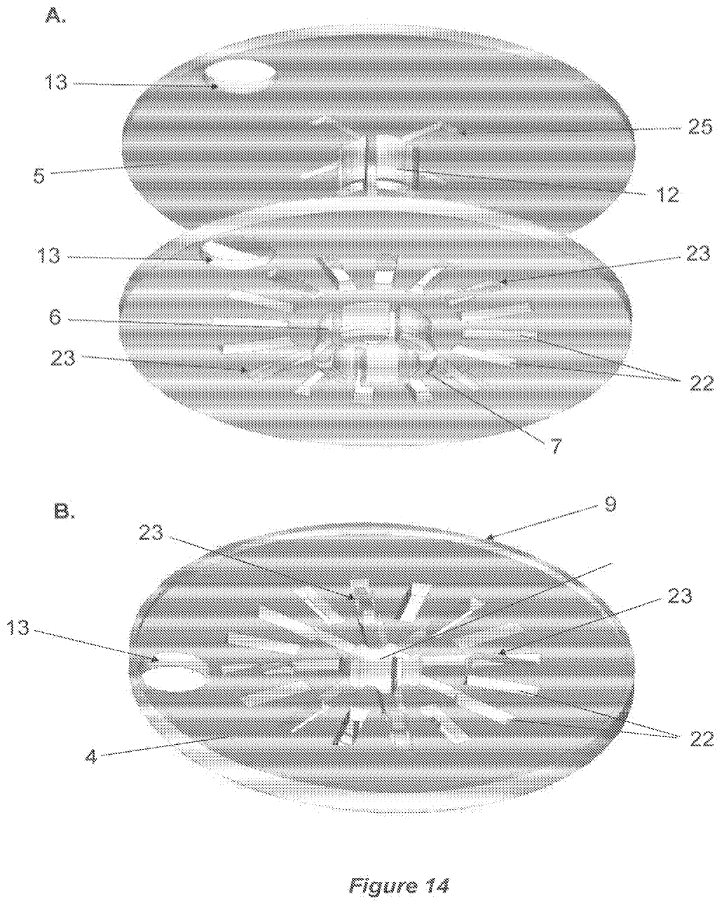

In some embodiments, both the lower lid (4) and the upper lid (5) of the child-resistant lid include an access port (13) which may be aligned, respectively. The access ports (13) are not limited to a particular size or shape, but may be of any size or shape necessary to provide access to the one or more compartments (3) in the housing (1) of the child-resistant container. In some illustrative embodiments, the one or more access ports (13) are circular in various sizes, as shown in FIGS. 1, 2, 5-7, and 12-17. In other illustrative embodiments, the one or more access ports (13) are square or rectangular, as shown in FIGS. 10 and 11. In still other embodiments, the one or more access ports (13) are oval or oblong in various sizes, as shown in FIGS. 21, 22, and 24-26.

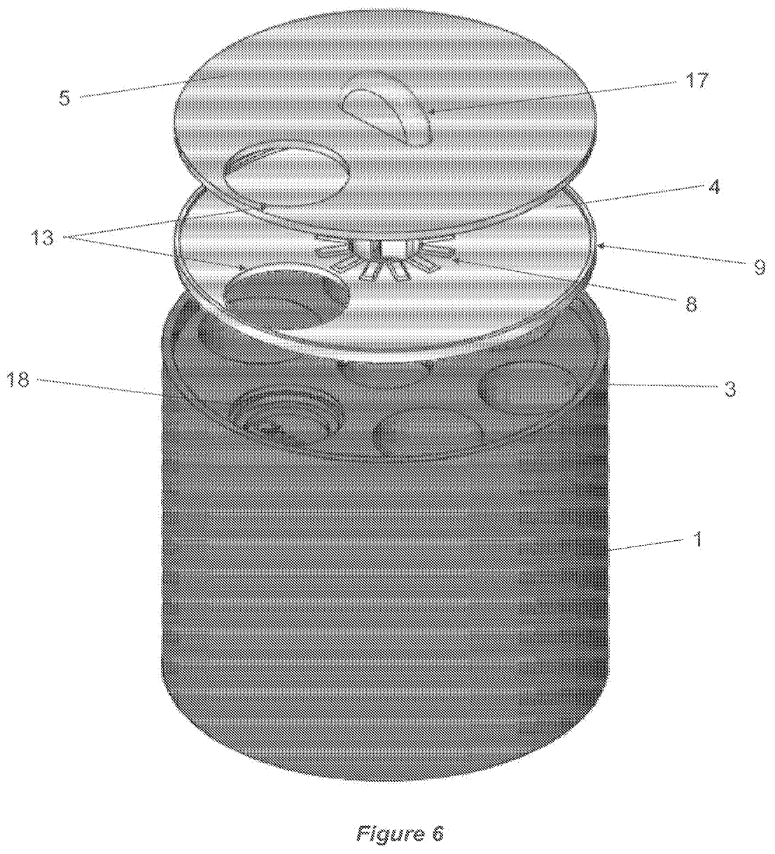

The lower lid (4) is normally positioned such that the access port (13) is in the closed position to block access to the one or more compartments (3). In some embodiments, the upper lid (5) is capable of rotating without rotating the lower lid (4) when the upper lid (5) is not depressed. When the access port (13) on the upper lid (5) is aligned with the access port (13) on the lower lid (4), the two-piece lid may be rotated to access one or more of the compartments (3), or the contents of the one or more compartments (3). The lower lid (4) may be rotated by depressing the top of the two-piece cap, flexing the cap material like a spring, causing the raised ridges or teeth (8) around the base of the tubular projection (6) on the top surface of the lower lid (4) to interact with or fit into the recesses, grooves or slots (10) on the bottom surface of the upper lid (5), and rotating the two-piece child-resistant lid. In some embodiments, the two-piece child-resistant lid may be rotated in one direction. In some embodiments, the two-piece child-resistant lid may be rotated either clockwise or counterclockwise. The one or more compartments (3) may be accessed by aligning the access ports (13) and rotating the two-piece child-resistant lid until the one or more compartments (3) is exposed. The access ports (13) may be of any appropriate size or shape to allow access to the one or more compartments (3) or the contents of said compartments (3). In some embodiments, the top surface of the upper lid (5) of the two-piece child-resistant lid includes a knob (17), as shown in FIG. 6. In some embodiments, the knob (17) is located in the center of the upper lid (5). As shown in FIG. 6, in some embodiments, the cylindrical housing (1) includes a false cavity (18) which is visible when the access ports (13) of the lower lid (4) and the upper lid (5) are aligned in the closed position. In some embodiments, the false cavity (18) is layered. In some embodiments, the edges of the access ports (13) on the lower lid (4) and the upper lid (5) are tapered.

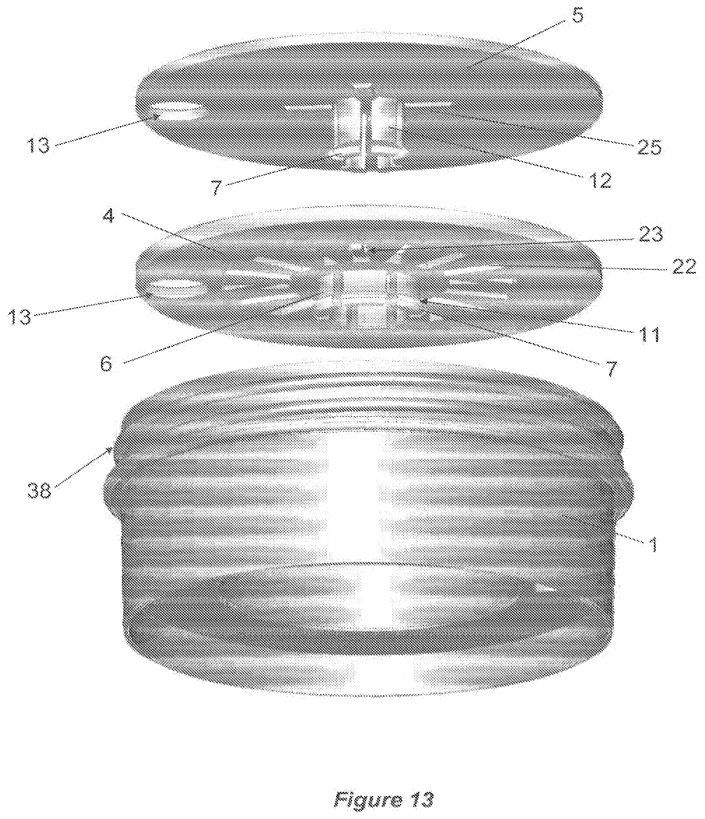

In some embodiments, as shown in FIGS. 12-14, the lower lid (4) of the child-resistant lid includes one or more channels (22) located or arrayed around the opening for the tubular projection (6), one or more of which include a finger-like projection (23) molded to the lower lid (4). In some embodiments, the bottom of the upper lid (5) of the child-resistant lid includes one or more raised ridges or teeth (25) arrayed around the tubular projection (12). When the access port (13) on the upper lid (5) is aligned with the access port (13) on the lower lid (4), the one or more raised ridges or teeth (25) arrayed the tubular projection (12) on the bottom of the upper lid (5) align with the one or more channels (22) located or arrayed around the opening for the tubular projection (6) of the lower lid (4) that include a finger-like projection (23) molded to the lower lid (4). In such embodiments, these finger-like projections (23) are angled such that they fit into or interlock with recesses, grooves, slots, depressions or channels (24) arrayed around the center (2) of the housing (1) when the child-resistant feature is engaged. When the access ports (13) are aligned and the top of the two-piece lid is depressed, the upper lid (5) interacts with the lower lid (4) causing the one or more raised ridges or teeth (25) on the bottom of the upper lid (5) to interact with and disengage the finger-like projections (23) from the recesses, grooves, slots, depressions or channels (24) arrayed around the center (2) of the housing (1), allowing for rotation of the lower lid (4). In some embodiments, the finger-like projections (23) are angled when the child-resistant feature is engaged.

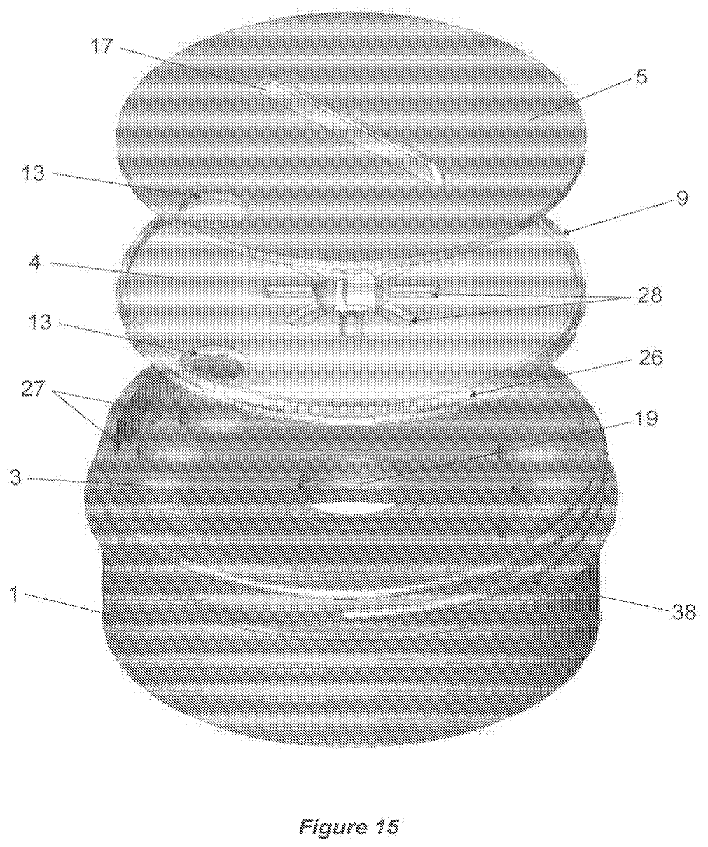

In some embodiments, as shown in FIGS. 15-17, the outer edge of the lower lid (4) of the child-resistant lid includes gear-like teeth or a cog (26) that engage with gear-like teeth (27) located on the body of the housing (1), preventing the lower lid (4) from rotating when the child-resistant feature is engaged, or in the neutral position. In some embodiments, the top of the lower lid (4) includes one or more recesses, grooves, slots or depressions (28) arrayed around the opening for the tubular projection (6). In such embodiments, the bottom of the upper lid (5) also includes one or more raised ridges or teeth (29) arrayed around the tubular projection (12) that align with the one or more recesses, grooves, slots or depressions (28) located on the top of the lower lid (4), particularly when the access port (13) on the upper lid (5) is aligned with the access port (13) on the lower lid (4). In such embodiments, when the top of the two-piece lid is depressed, the upper lid (5) interacts with the lower lid (4), causing the gear-like teeth or cog (26) located on the outer edge of the lower lid (4) to move below the gear-like teeth or cog (27) located on the body of the housing (1) and the one or more raised ridges or teeth (29) on the bottom of the upper lid (5) to fit into or interlock with the one or more recesses, grooves, slots or depressions (28) on the top of the lower lid (4), allowing for rotation of the lower lid (4).

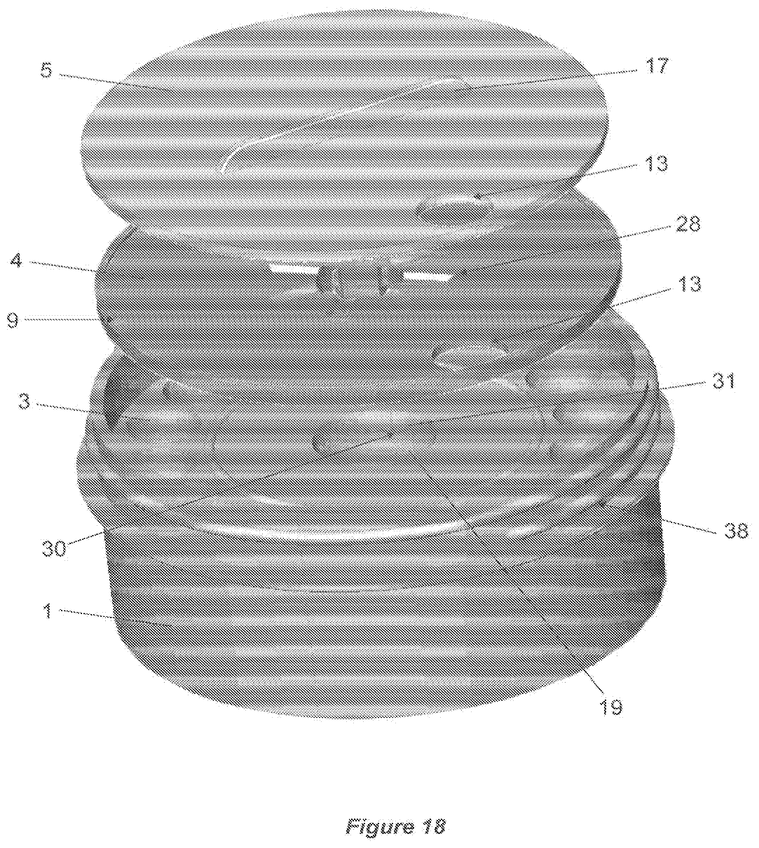

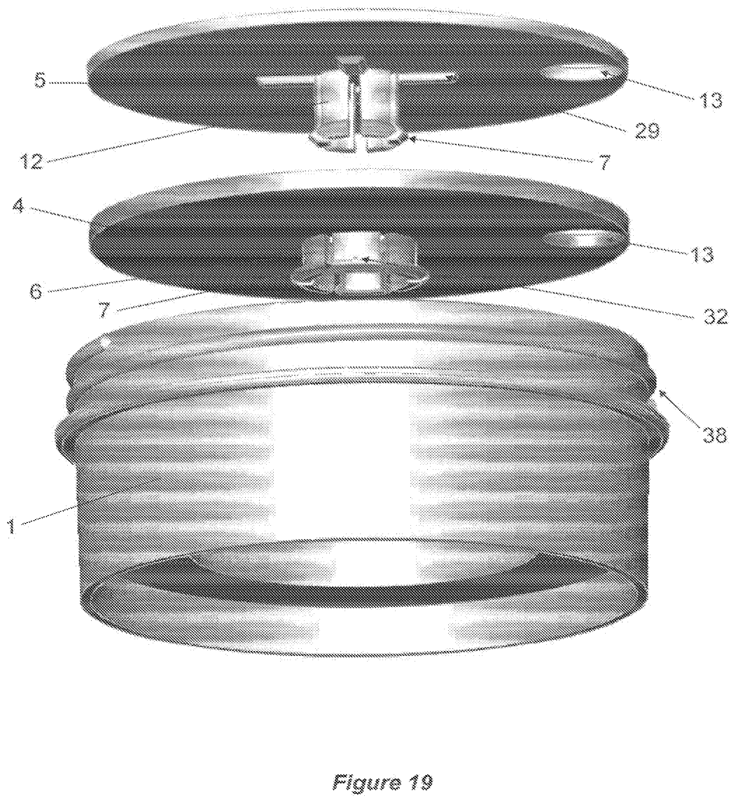

In some embodiments, as shown in FIGS. 18-20, the hollow or tunnel (19) in the center (2) of the housing (1) includes raised ridges or teeth (30) around the circumference of the hollow or tunnel (19). In certain embodiments, the raised ridges or teeth (30) are located on the bottom edge of a lip (31) around the circumference of the hollow or tunnel (19). The tubular projection (6) on the lower lid (4) of the child-resistant lid includes one or more raised ridges or teeth (32) located on the top of the collar (7) of the tubular projection (6), such that the one or more raised ridges or teeth (32) located on the top of the collar (7) are engaged with or positioned in between two of the raised ridges or teeth (30) located in the hollow or tunnel (19) and/or on the bottom edge of the lip (31) in the hollow or tunnel (19), preventing rotation of the lower lid (4). As identified above, in some embodiments, the top of the lower lid (4) includes one or more recesses, grooves, slots or depressions (28) arrayed around the opening for the opening for the tubular projection (6). In such embodiments, the bottom of the upper lid (5) also includes one or more raised ridges or teeth (29) arrayed around the tubular projection (12) that align with the one or more recesses, grooves, slots or depressions (28) located on the top of the lower lid (4), particularly when the access port (13) on the upper lid (5) is aligned with the access port (13) on the lower lid (4). In such embodiments, when the top of the two-piece lid is depressed, the upper lid (5) interacts with the lower lid (4), causing the one or more raised ridges or teeth (32) located on the top of the collar (7) to move below the raised ridges or teeth (30) in the hollow or tunnel (19) and/or on the bottom edge of the lip (31) in the hollow or tunnel (19) and the one or more raised ridges or teeth (29) on the bottom of the upper lid (5) to fit into or interlock with the one or more recesses, grooves, slots or depressions (28) on the top of the lower lid (4), allowing for rotation of the lower lid (4). Such embodiments do not require friction for the child-resistant lock to function and operate properly.

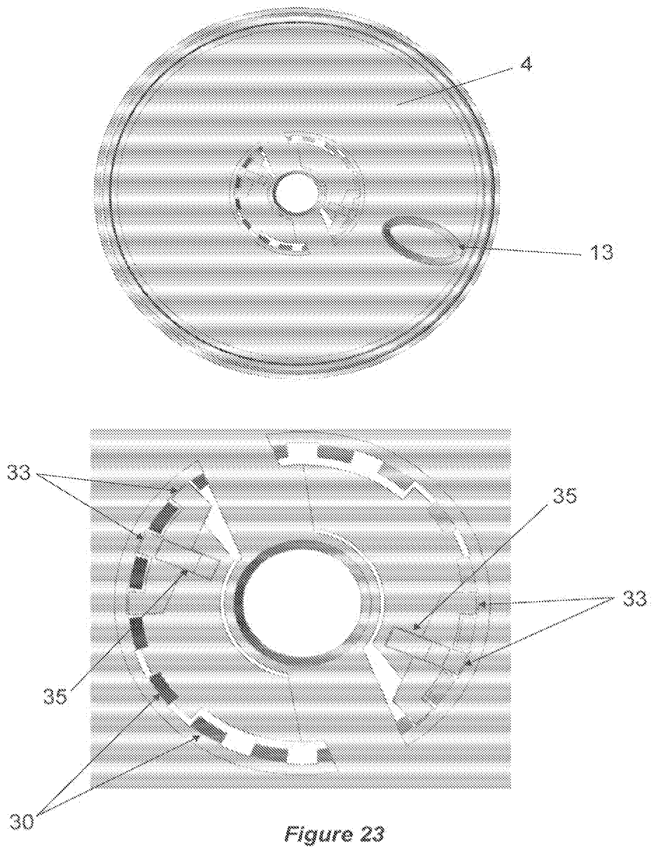

In some embodiments, as shown in FIGS. 21-26, the hollow or tunnel (19) in the center (2) of the housing (1) includes raised ridges or teeth (30) around the circumference of the hollow or tunnel (19). In such embodiments, the lower lid (4) includes one or more spring-like flaps (33) with ridges or teeth (34) located in the hollow or void around the circumference of the tubular projection (6) on the lower lid (4). The top of each spring-like flap (33) on the lower lid (4) includes a raised protrusion or tooth (35). In such embodiments, the bottom of the upper lid (5) includes one or more recesses, grooves, slots or depressions (36) around the tubular projection (12) each of which align with the raised protrusions or teeth (35) located on top of each spring-like flap (33) located on the top of the lower lid (4), particularly when the access port (13) on the upper lid (5) is aligned with the access port (13) on the lower lid (4). In such embodiments, when the top of the two-piece lid is depressed, the upper lid (5) interacts with the lower lid (4), causing the one or more ridges or teeth (34) located on the spring-like flaps (33) to move below the raised ridges or teeth (30) in the hollow or tunnel (19), and the one or more recesses, grooves, slots or depressions (36) on the bottom of the upper lid (5) to fit into or interlock with the one or more raised protrusions or teeth (35) on the top of the spring-like flaps (33) on the lower lid (4), allowing for rotation of the lower lid (4) and access to the contents of a compartment (3). Such embodiments do not require friction for the child-resistant lock to function and operate properly. In some embodiments, when depressed and rotated, the two-piece child-resistant lid automatically indexes to a compartment (3).

In some embodiments, the child-resistant container also includes a removable lid (20), which may include one or more physical deterrents, such as a lock (21) or other physical deterrent to prevent improper access to the contents of the container or access at an improper time, as shown in FIGS. 10, 11, 24 and 25. In some embodiments, the interior of the removeable lid (20) includes threading (37) which matches to threading (38) located on the outside of the housing (1). In such embodiments, the lid is affixed by screwing the threading (37) on the removeable lid (20) on to threading (38) on the outside of the housing (1). In some embodiments, the removeable lid (20) is colorless or clear to allow for viewing of the top of the upper lid (5) of the two-piece child-resistant lid. In some embodiments, the child-resistant container includes a fill assister (42) which includes more than one opening (43) for filling the compartments (3). In some embodiments, the fill assister (42) includes an opening (43) of the appropriate size for at least each compartment (3). In certain embodiments, the fill assister (42) includes fewer openings (43) than one for each compartment (3) (e.g., a subset of the total number of compartments (3)). The fill assister (42) is rotated to fill each set of empty compartments (3), depending on the number of openings (43).

In some embodiments, the top surface of upper lid (5) includes a knob (17) to assist in depressing and rotating the two-piece child resistant lid. In certain embodiments, the top of the upper lid (5) is capable of fitting up to a 2-inch by 4-inch label (e.g., a pharmaceutical label). In some embodiments the label is applied by hand. In some embodiments the label is applied with a label presser (44) tool that presses the label to the top surface of the upper lid (5). In some embodiments the label is round. In some embodiments the label has a cut out for the handle or knob (17). In some embodiments, the label presser (44) and/or the fill assister (42) are made of cardboard, plastic or any pharmaceutically acceptable material, inclusive of those listed below.

Also disclosed herein is a method of filling the compartments of the child-resistant container with a product. As a non-limiting example, the container may be filled with pharmaceutical tablets or capsules. In such a method, a sticker (not shown) or the fill assister (42), as described above, that covers the hollow or tunnel (19) in the center of the housing is applied during manufacture of the child-resistant container. To fill the one or more compartments (3) of the housing (1), the tablets or capsules are poured onto the sticker or fill assister (42) and sorted into the compartments (3). The sticker or fill assister (42) is then removed, and the two-piece child-resistant lid is assembled and attached to the housing. In some instances, the one or more compartments are flat, allowing for easy removal of product from any compartment with excess product (i.e., too many capsules or tablets). In some embodiments, the fill assister (42) allows for rapid filing of the compartments (3) with minimal or no human contact with the product or pharmaceutical drug.

The pieces of the child-resistant container may be made of any acceptable material, as previously described herein, such as HDPE, polypropylene, polyethylene terephthalate, high density polyethylene, polyvinyl chloride, polystyrene, fluoropolymers, silicone, resins, polypropylene, nylon, polyethylene terephthalate and/or polylactide, which may be clear, tinted or opaque. In some embodiments, the pieces of the child-resistant container may be made of a pharmaceutically acceptable material, including the above-listed materials.

### EXAMPLES

### Example 1: Determining Optimum Tolerances for Child-Resistant Lid

As provided in some exemplary embodiments disclosed above, in order for the child resistant lid to function correctly, the tubular projection (6) on the lower lid (4) must be oversized compared to the tunnel in the center (2) of the housing (1). The oversizing of the tubular projection (6) on the lower lid (4) provides friction to prevent the lower lid (4) from rotating unless the upper lid (5) is pressed into it. Too little friction causes the lower lid to fail to resist rotation from a child, and may make it easy to dislodge the lid by shaking the container. Too much friction prevents an adult from opening the lid, and may cause breakage of the tubular projection (6) upon assembly of the lid. The optimum tolerances for the child-resistant lid were determined as related to (a) normal use of the child-resistant container: (b) shaking the container when completely full; and (c) assembling the child-resistant container without breakage of parts. Several prototypes were created with the dimensions as identified in Table 1. Optimum tolerances were determined for each prototype on a pass/fail basis, as detailed below and in Tables 1-3.

### (a) Normal Use of the Child-Resistant Container (“CR”):

Determine the optimum tolerance for the child-resistance lid under normal conditions of use required determining whether the upper lid rotates freely without moving or rotating the lower lid, unless and until the child-resistant function is properly engaged by pressing down on the upper lid, causing the upper lid to interact with the lower lid, and rotating the two-piece lid. As provided in Tables 1-3, each prototype was assembled and used under normal operation. A fail rating for a prototype indicates that (i) the upper lid did not rotate freely, (ii) the lower lid moved or rotated when attempting to rotate the upper lid without deactivating the child-resistant feature by pressing down on the upper lid and turning, thereby rotating the lower lid, (iii) the lower lid did not rotate when pressed down on by the upper lid, or (iv) the lower lid did not rotate except with use of excessive force by an average adult.

The results in Tables 1 and 2 for the “CR” test show that all prototypes failed under normal operation. All prototypes shown in Table 1 were 3D printed in PolyJet Rigur polypropylene photopolymer material. As shown in Table 1, Prototype 1 failed because, while the 17.5 mm inserted, it was tightly bound. The collar broke upon lid removal, indicating that 17.5 mm is not a desirable preload. Prototype 2 failed because the child-resistant lid did not consistently function. Sometimes the lid was too hard to turn and other times the upper and lower lid easily rotate together. Prototype 3, with 18.5 mm appears to be the best, as the upper lid rotates freely, and when pressing down on the upper lid, the two-pieces of the lid rotate easily. However, this prototype failed the CR test because of inconsistent function, as sometimes the upper and lower lids rotate easily when no pressure is applied.

Three additional prototypes were 3D printed in selective laser sintering (“SLS”) using a nylon material. The results for these three prototypes are shown in Table 2. As shown in Table 2, all prototypes, SLS1, SLS2 and SLS 3, failed the CR test because they were too tight. This is likely due to the SLS having a rougher surface texture than the polymer Rigur. In addition, SLS1 failed the CR test because, while the 18.4 mm is rotatable by hand, the force required is likely too much for the average user.

The three SLS prototypes were machined in a vertical mill to expand the inner measurement of the opening in the center of the housing until a good CR function was established. The lid was attached and removed multiple times at different mill settings to establish ideal function. Table 3 provides the actual measurements for the inner dimension of the opening in the center of the housing “Opening in center of housing—Inner” and the outer dimension of the tubular projection on the lower lid “Lower lid tubular projection—Outer”, rather than intended measurements from 3D printing. Table 3 shows that all three of the machined SLS prototypes passed the CR test. The difference between the “Lower lid tubular projection—Outer” measurement and the “Opening in center of housing—Inner” measurements are: SLS1: 0.03 mm; SLS2: 0.03 mm; and SLS3: 0.06 mm. As detailed here and below, the results from Tables 1-3 identify that the three machined SLS prototypes performed the best during the CR, Shake and Break tests.

(b) Shaking the Child-Resistant Container when Full:

To determine the optimum tolerance for integrity of the child-resistant container and components of the child-resistant lid when the compartment is 100% full, coins were placed in each compartment until 100% full. The results of the “Shake” test for each prototype are shown in Tables 1-3.

In Table 1, prototype KB1 failed the shake test. As with the CR test, Prototype 1 failed the Shake test because, while the 17.5 mm inserted, it was tightly bound and the collar broke upon lid removal, prior to shake testing. Prototype 2 failed the shake test, revealing broken collar pieces which were possibly broken during assembly. This possibly explains the inconsistent CR results for Prototype 2, detailed above in (a). Prototype 4 also failed the Shake test. While the lid did not dislodge, it did “click” back into place after completion of the Shake test. Both IB1 and Prototype 3 passed the shake test.

Table 2 shows the results from the three additional prototypes 3D printed in SLS. Each of these prototypes passed the Shake test.

Table 3 shows the results for the three SLS prototypes machined in a vertical mill. Each of these three machined prototypes also passed the Shake test.

### (c) Assembling the Child-Resistant Container:

To determine the optimum tolerance for integrity of the child-resistant container and each component of the child-resistant lid when assembling, several prototypes were made with the dimensions as provided in Table 1. The components were all assembled and the integrity of each component was tested to determine whether any component broke upon assembly, based on a pass/fail test. Results of the assembly test (“Break”) are shown in Tables 1-3.

In Table 1, KB1, IB1, Prototype 3 and Prototype 4 all passed the assembly Break test. As in the other two tests, Prototype 1 failed the Break test because, while the 17.5 mm inserted, it was tightly bound and the collar broke upon lid removal, indicating that 17.5 mm is not a desirable preload. Similarly to the Shake test in (b), Prototype 2 also failed the Break test, revealing broken collar pieces which were possibly broken during assembly.

Table 2 shows the results for the Break test for the three additional prototypes 3D printed in SLS. As with the Shake test in (b), each of these prototypes passed the Break test.

Table 3 shows the results for the Break test for the three SLS prototypes machined in a vertical mill. Again, as with the Shake test in (b), each of these three machined prototypes passed the Shake test.

TABLE 1
Testing prototypes 3D printed in PolyJet Rigur.

| | Dimensions (mm) | | | | | | | | |
|---|---|---|---|---|---|---|---|---|---|
| | | | | | | Opening in | | | |
| | Upper lid tubular | | Lower lid tubular | | | center of | Optimum tolerance | | |
| | projection | | projection | | | housing | CR | Shake | Break |
| Name | Outer | Collar | Inner | Outer | Collar | Inner | P/F | P/F | P/F |
| KB1 | 13.4 | 14.3 | 13.8 | 18.2 | 18.6 | 18.6 | F | F | P |
| IB1 | 12.75 | 14.3 | 14.0 | 18.2 | 18.5 | 18.5 | F | P | P |
| Prototype 1 | 13.0 | 15.0 | 14.0 | 18.5 | 19.5 | 17.5 | F*1 | F*1 | F*1 |
| Prototype 2 | 13.0 | 15.0 | 14.0 | 18.5 | 19.5 | 18.0 | F*2 | F*5 | F*5 |
| Prototype 3 | 13.0 | 15.0 | 14.0 | 18.5 | 19.5 | 18.5 | F*3 | P | P |
| Prototype 4 | 13.0 | 15.0 | 14.0 | 18.5 | 19.5 | 19.0 | F | P*4 | P |

*117.5 mm inserted but was tightly bound, and the collar broke upon removal of lid.
*2CR does not function consistently.
*318.5 mm operated the best, but the OR does not function consistently.
*4Lid did not dislodge, but “clicked” back in place after Shake test.
*518.0 mm failed Shake test, and the collar was broken.

TABLE 2
Testing prototypes 3D printed in SLS.

| | Dimensions (mm) | | | | | | | | |
|---|---|---|---|---|---|---|---|---|---|
| | | | | | | Opening in | | | |
| | Upper lid tubular | | Lower lid tubular | | | center of | Optimum tolerance | | |
| | projection | | projection | | | housing | CR | Shake | Break |
| Name | Outer | Collar | Inner | Outer | Collar | Inner | P/F | P/F | P/F |
| SLS1 | 13.0 | 15.0 | 14.0 | 18.5 | 19.5 | 18 4 | F*6*7 | P | P |
| SLS2 | 13.0 | 15.0 | 14.0 | 18.5 | 19.5 | 18 3 | F*6 | P | P |
| SLS3 | 13.0 | 15.0 | 14.0 | 18.5 | 19.5 | 18.2 | F*6 | P | P |

*6Too tight; the SLS is a rougher surface texture than polymer Rigur and all sizes were too tight.
*718.5 mm is rotatable by hand, but the force required may be too much for the average user.

TABLE 3
Testing machined SLS prototypes and determining a functional preload.

| | Dimensions (mm) | | | | | | | | |
|---|---|---|---|---|---|---|---|---|---|
| | | | | | | Opening in | | | |
| | Upper lid tubular | | Lower lid tubular | | | center of | Optimum tolerance | | |
| | projection | | projection | | | housing | CR | Shake | Break |
| Name | Outer | Collar | Inner | Outer | Collar | Inner | P/F | P/F | P/F |
| SLS1 | 13.0 | 15.0 | 14.0 | 18.45 | 19.5 | 18.42 | P | P | P |
| SLS2 | 13.0 | 15.0 | 14.0 | 18.48 | 19.5 | 18.45 | P | P | P |
| SLS3 | 13.0 | 15.0 | 14.0 | 18.55 | 19.5 | 18.49 | P | P | P |

Based on the above results, in order to have a prototype pass the CR, Shake, and Break PG-3T tests, the tubular projection (6) needs to be oversized between 0.03 mm-0.06 mm as compared to the Opening in the center of the housing,—Inner. However, 0.03 mm-0.06 mm is a tighter manufacturing tolerance than would be consistently achievable by an injection molding process. Therefore an alternative design is necessary to manufacture a child resistant lid with the quality to consistently pass testing.

### Example 2: Determining Optimum Tolerances for Child-Resistant Lid with an Easy to Manufacture

In an alternative design, preload friction is achieved by oversizing the collar (7) on the tubular projection (6) of the lower lid in comparison with the diameter of the tunnel (19) that exists within the opening in the center of the housing. The collar (7) is located at the distal end of the tubular projection (6) of the lower lid (4). Increasing the distance of the friction point to the lower lid (4) results in a larger physical distance variation of the friction points, enabling a satisfactory preload. The surprising result of using this alternative design is that the lid can be constructed using inexpensive injection molding techniques that will consistently meet specifications.

The optimum tolerances for the alternative design of the child-resistant lid were determined as related to (a) normal use of the child-resistant container; (b) shaking the container when completely full; and (c) assembling the child-resistant container without breakage of parts, as detailed in Example 1. Several prototypes were created with the dimensions as identified in Table 4. Optimum tolerances were determined for each prototype on a pass/fail basis, as detailed below and in Table 4.

### (a) Normal Use of the Child-Resistant Container (“CR”):

The optimum tolerance for the child-resistance lid under normal conditions of use was determined as described in Example 1. As provided in Table 4, each prototype was assembled and used under normal operation. The results in Table 4 show that each of Prototypes 4-8 passed the “CR” test.

(b) Shaking the Child-Resistant Container when Full:

The optimum tolerance for integrity of the child-resistant container and components of the child-resistant lid when the compartment is 100% full was determined as described in Example 1. The results of the “Shake” test for each prototype are shown in Table 4, which indicates that each of the prototypes passed the “Shake” test. However, in Prototypes 4 and 7, the upper lid partially dislodged.

### (c) Assembling the Child-Resistant Container:

The optimum tolerance for integrity of the child-resistant container and each component of the child-resistant lid when assembling was determined as described in Example 1. Several prototypes were made with the dimensions as provided in Table 4. Results of the assembly test (“Break”) are shown in Table 4. Each of Prototypes 4-8 passed the “Break” test.

TABLE 4
Testing alternative design prototypes and determining a functional preload.

| | Dimensions (mm) | | | | | | | | | |
|---|---|---|---|---|---|---|---|---|---|---|
| | Upper lid tubular | | Lower lid tubular | | | Opening in | | Optimum tolerance | | |
| | projection | | projection | | | center of housing | | CR | Shake | Break |
| Name | Outer | Collar | Inner | Outer | Collar | Inner | Tunnel | P/F | P/F | P/F |
| Prototype 5 | 13.0 | 15.0 | 14.0 | 18.43 | 19.37 | 18.65 | 19.49 | P | P*8 | P |
| Prototype 6 | 13.0 | 15.0 | 14.0 | 18.45 | 19.50 | 18.65 | 19.49 | P | P | P |
| Prototype 7 | 13.0 | 15.0 | 14.0 | 18.52 | 19.66 | 18.65 | 19.49 | P | P | P |
| Prototype 8 | 13.0 | 15.0 | 14.0 | 18.55 | 19.70 | 18.65 | 19.49 | P*9 | P*8 | P |
| Prototype 9 | 13.0 | 15.0 | 14.0 | 18.49 | 19.82 | 18.65 | 19.49 | P*9 | P | P |

*8All coins stayed in but the upper lid partially dislodged. The upper lid may have been dislodged by the flex of the lower lid while being struck by coins during shake testing.
*9This CR was noticeably firmer. This firmness is preferable.

The results of Example 1 show that in order to create a child resistant lid with an acceptable preload, if the preload is generated by contact between the tubular projection (6) on the lower lid (4) and the Opening in the center of housing—Inner, then the tolerances will be tighter than can generally be achieved through an injection molding process. Specifically, in Example 1, the allowable tolerance requires the upper lid to be oversized by a narrow range of 0.03 mm-0.06 mm to have consistent performance.

However, as shown in Example 2, moving the preload contact to the distal end of the tubular projection results in a preload contact generated between the collar (7) on the tubular projection (6) of the lower lid (4) and the tunnel (19) located in the opening in the center (2) of the housing (1). This change increases the allowable tolerance range to 0.01 mm-0.33 mm. The dimensions for the Prototypes as shown in Table 4 provide for this allowable tolerance range, which is easily within the range of an injection molding process, enabling a consistent design that is easy to manufacture.

### Example 3: Compartment Fill Times Using Fill Assisters

To determining the approximate speed within which the compartments of the child-resistant container can be filled using fill assisters, trials were conducted using a container with fifteen (15) compartments. Time to fill all fifteen (15) compartments was assessed using a fill assister with either five (5) openings or fifteen (15) openings. The results are shown below in Table 5. The average time for filing all fifteen (15) compartments using either fill assister was under a minute. Specifically, the average time using the fill assister with fifteen (15) compartments was at 34.7 seconds, while the average time using the fill assister with five (5) compartments was 47.2 seconds.

Use of either fill assister resulted in few errors, such as pills popping out or the need to use one or more fingers to place a pill in one or more container. However, the preliminary trials show that using the fill assister with one opening for each compartment resulted in a reduced amount of time to properly fill each compartment with the appropriate number of pharmaceutical pills and with fewer errors than the fill assister with five (5) openings.

TABLE 5
Fill times using a fill assister.
Initial Disposal Pack Filling Trials

| | Fill assister | | |
|---|---|---|---|
| | openings | | |
| Subject | (5 or 15) | Time | Errors |
| 1 | 15 | 01:11.9 | 1 popped out |
| 1 | 5 | 01:04.5 | |
| 2 | 5 | 01:14.7 | 1 popped out |
| 2 | 15 | 00:33.6 | |
| 2 | 5 | 00:45.8 | |
| 2 | 15 | 00:36.6 | 1 use of fingers |
| 2 | 5 | 00:48.0 | |
| 2 | 15 | 00:35.3 | |
| 3 | 15 | 00:40.6 | |
| 3 | 5 | 00:37.5 | |
| 3 | 15 | 00:19.7 | |
| 3 | 5 | 00:34.9 | |
| 3 | 15 | 00:20.7 | |
| 3 | 5 | 00:35.7 | |
| 1 | 15 | 00:24.9 | |
| 1 | 5 | 00:42.6 | 1 popped out |
| 1 | 15 | 00:28.6 | 1 popped out |
| 1 | 5 | 00:40.9 | |
| AVERAGE | 5 | 00:47.2 | |
| AVERAGE | 15 | 00:34.7 | |

Although this disclosure includes various exemplary embodiments of the invention, it will be apparent that those skilled in the art can make various modifications that will achieve some of the advantages of the invention without departing from the true scope of the invention.

What is claimed is:

1. A device for a child-resistant container, the device comprising:
a housing comprising:
(a) one or more compartments; and
(b) an opening to a tunnel in the center of the housing;
a child-resistant lid comprising:
(a) a lower lid comprising
(i) a tubular projection in the center,
(ii) one or more raised ridges or teeth on the top surface of the lower lid; and
(iii) an access port for accessing said one or more compartments;
(b) an upper lid comprising:
(i) a tubular projection in the center,
(ii) one or more recesses, grooves, slots or depressions on the bottom surface of the upper lid, and
(iii) an access port for accessing said one or more compartments.

2. The device of claim 1, further comprising a collar on the tubular projection of the lower lid and the tubular projection of the upper lid.

3. The device of claim 2, wherein the collar is located at the distal end of each of the tubular projection of the lower lid and the tubular projection of the upper lid.

4. The device of any one of claims 1-3, further comprising one or more striations on the circumference of the tubular projection of the lower lid.

5. The device of any one of claims 1-4, further comprising a lip around a circumference of the top surface of the lower lid.

6. The device of any one of claims 1-5, further comprising a knob in the center of the top surface of the upper lid.

7. The device of any one of claims 1-6, further comprising a false cavity in the housing, wherein the false cavity is visible when the access port on the lower lid and the access port on the upper lid are aligned and in the closed position.

8. The device of any one of claims 1-7, wherein the one or more raised ridges or teeth on the top surface of the lower lid are 0.5 mm in height, the recesses, grooves or slots on the bottom surface of the upper lid are 0.5 mm in depth.

9. The device of claim 5, wherein the lip around the circumference of the top surface of the lower lid is 1.0 mm in height.

10. The device of any one of claims 1-9, further comprising one or more raised ridges or teeth arranged around the circumference of the hollow or tunnel in the center of the housing, wherein the one or more recesses, grooves, slots or depressions are arranged around the tubular projection on the bottom of the upper lid, and wherein the lower lid further comprises one or more spring-like flaps comprising ridges or teeth, the one or more spring-like flaps being located in a hollow or void surrounding the tubular projection on the lower lid.

11. The device of claim 10, wherein the top of each spring-like flap on the lower lid comprises a raised protrusion or tooth that aligns with the one or more recesses, grooves, slots or depressions around the tubular projection, particularly when the access port on the upper lid is aligned with the access port on the lower lid.

12. The device of any one of claims 1-9, further comprising a preload friction tolerance range of 0.01 mm-0.33 mm between the collar on the tubular projection of the lower lid and the tunnel in the center of the housing.

13. A two-piece child-resistant lid comprising:
a lower lid comprising:
(a) a tubular projection in the center;
(b) one or more raised ridges or teeth on the top surface of the lower lid; and
(c) an access port for accessing one or more compartments in a housing; and
an upper lid comprising:
(a) a tubular projection in the center, wherein the tubular projection of the upper lid fits inside and attaches to the tubular projection of the lower lid;
(b) one or more recesses, grooves, slots or depressions on the bottom surface of the upper lid; and
(c) an access port for accessing said one or more compartments,
wherein the access port of the upper lid is capable of lining up with the access port of the lower lid, and wherein said one or more compartments may be accessed by depressing the top of the upper lid of the child-resistant lid and rotating the cap clockwise or counter-clockwise.

14. The device of claim 13, further comprising a collar on the tubular projection of the lower lid and the tubular projection of the upper lid.

15. The device of claim 14, wherein the collar is located at the distal end of each of the tubular projection of the lower lid and the tubular projection of the upper lid.

16. The device of any one of claims 13-15, further comprising one or more striations on the circumference of the tubular projection of the lower lid.

17. The device of any one of claims 13-16, further comprising a lip around a circumference of the top surface of the lower lid.

18. The device of any one of claims 13-17, further comprising a knob in the center of the top surface of the upper lid.

19. The device of any one of claims 13-18, wherein the one or more raised ridges or teeth on the top surface of the lower lid are 0.5 mm in height, and the one or more recesses, grooves, slots or depressions on the bottom surface of the upper lid are 0.5 mm in depth.

20. The device of claim 17, wherein the lip around the circumference of the top surface of the lower lid is 1.0 mm in height.

21. The device of any one of claims 13-20, further comprising one or more raised ridges or teeth arranged around the circumference of the hollow or tunnel in the center of the housing, wherein the one or more recesses, grooves, slots or depressions are arranged around the tubular projection on the bottom of the upper lid, and wherein the lower lid further comprises one or more spring-like flaps comprising ridges or teeth, the one or more spring-like flaps being located in a hollow or void surrounding the tubular projection on the lower lid.

22. The device of claim 21, wherein the top of each spring-like flap on the lower lid comprise a raised protrusion that align with the one or more recesses, grooves, slots or depressions around the tubular projection, particularly when the access port on the upper lid is aligned with the access port on the lower lid.

23. A method of accessing a child-restraint container, the method comprising:
providing:
(1) a housing comprising:
(a) one or more compartments; and
(b) an opening to a tunnel in the center of the housing;
(2) a child-resistant lid comprising:
(a) a lower lid comprising
(i) a tubular projection, wherein the tubular projection is inserted into and attached to the tunnel within the center of the housing,
(ii) one or more raised ridges or teeth on the top surface of the lower lid; and
(iii) an access port for accessing said one or more compartments;
(b) an upper lid comprising:
(i) a tubular projection in the center, wherein the tubular projection of the upper lid is inserted into and attached to the tubular projection of the lower lid;
(ii) one or more recesses, grooves, slots or depressions on the bottom surface of the upper lid; and
(iii) an access port for accessing said one or more compartments;
lining up the access port of the upper lid with the access port of the lower lid;
depressing the top of the upper lid of the child-resistant lid; and
rotating the lid clockwise or counter-clockwise until the access port is lined up with one or more of the compartments.

24. A device for a child-resistant container, the device comprising:
a housing comprising:
(a) one or more compartments; and
(b) an opening to a tunnel in the center of the housing;
a child-resistant lid comprising:
(a) a lower lid comprising
(i) a tubular projection in the center,
(ii) one or more recesses, grooves, slots, depressions or channels on the top surface of the lower lid; and
(iii) an access port for accessing said one or more compartments;
(b) an upper lid comprising:
(i) a tubular projection in the center,
(ii) one or more raised ridges or teeth on the bottom surface of the upper lid; and
(iii) an access port for accessing said one or more compartments.

25. The device of claim 24, further comprising a collar on the tubular projection of the lower lid and the tubular projection of the upper lid.

26. The device of claim 25, wherein the collar is located at the distal end of the tubular projection of the lower lid and the tubular projection of the upper lid.

27. The device of any one of claims 24-26, further comprising one or more striations on the circumference of the tubular projection of the lower lid.

28. The device of any one of claims 24-27, further comprising a lip around a circumference of the top surface of the lower lid.

29. The device of any one of claims 24-28, further comprising a knob in the center of the top surface of the upper lid.

30. The device of any one of claims 24-29, further comprising one or more raised ridges or teeth arranged around the circumference of the outer edge of the lower lid and one or more raised ridges or teeth arranged around the inner circumference of the outer edge of the housing.

31. The device of any one of claims 24-29, further comprising one or more raised ridges or teeth arranged around the circumference of the hollow or tunnel located in the center of the housing and one or more one or more raised ridges or teeth arranged on the top side of the collar of the tubular projection on the lower lid.

32. The device of any one of claims 24-29, further comprising one or more recesses, grooves, slots or depressions arranged around center of the opening to the tunnel on the top surface of the housing, and wherein the channels located or arrayed around the opening for the tubular projection on top of the lower lid comprise one or more angled finger-like projections molded to the lower lid.

33. The device of any one of claims 28-32, wherein the one or more raised ridges or teeth or finger-like projections on the top surface of the lower lid are 0.5 mm in height, and the one or more recesses, grooves, slots or depressions on the bottom surface of the upper lid are 0.5 mm in depth.

34. The device of any one of claims 28-33, wherein the lip around the circumference of the top surface of the lower lid is 1.0 mm in height.

35. A two-piece child-resistant lid comprising:
a lower lid comprising:
(a) a tubular projection in the center;
(b) one or more recesses, grooves, slots, depressions or channels on the top surface of the lower lid; and
(c) an access port for accessing one or more compartments in a housing; and
an upper lid comprising:
(a) a tubular projection in the center, wherein the tubular projection of the upper lid fits inside and attaches to the tubular projection of the lower lid;
(b) one or more raised ridges or teeth on the bottom surface of the upper lid; and
(c) an access port for accessing said one or more compartments,
wherein the access port of the upper lid is capable of lining up with the access port of the lower lid, and wherein said one or more compartments may be accessed by depressing the top of the upper lid of the child-resistant lid and rotating the cap clockwise or counter-clockwise.

36. The device of claim 35, further comprising a collar on the tubular projection of the lower lid and the tubular projection of the upper lid.

37. The device of claim 36, wherein the collar is located at the distal end of the tubular projection of the lower lid and the tubular projection of the upper lid.

38. The device of any one of claims 35-37, further comprising one or more striations on the circumference of the tubular projection of the lower lid.

39. The device of any one of claims 35-38, further comprising a lip around a circumference of the top surface of the lower lid.

40. The device of any one of claims 35-39, further comprising a knob in the center of the top surface of the upper lid.

41. The device of any one of claims 35-40, further comprising one or more of:
one or more raised ridges or gear-like teeth arranged around the circumference of the outer edge of the lower lid and one or more raised ridges or gear-like teeth arranged around the inner circumference of the body of the housing;
one or more raised ridges or teeth arranged on the top side of the collar of the tubular projection on the lower lid and one or more raised ridges or teeth arranged around the circumference of the hollow or tunnel in the center of the housing: or
one or more angled finger-like projections within the channels located or arrayed around the opening for the tubular projection on top of the lower lid, wherein the angled finger-like projections are molded to the lower lid and one or more raised ridges or teeth arrayed around the tubular projection on the bottom of the upper lid.

42. The device of any one of claims 35-41, wherein the raised ridges or teeth on the top surface of the lower lid are 0.5 mm in height, the recesses, grooves, slots or channels on the bottom surface of the upper lid are 0.5 mm in depth.

43. The device of claim 42, wherein the lip around the circumference of the top surface of the lower lid is 1.0 mm in height.

44. A method of accessing a child-restraint container, the method comprising:
providing:
(1) a housing comprising:
(a) one or more compartments; and
(b) an opening to a tunnel in the center of the housing;
(2) a child-resistant lid comprising:
(a) a lower lid comprising
(i) a tubular projection, wherein the tubular projection is inserted into and attached to the tunnel within the center of the housing,
(ii) one or more recesses, grooves, slots, depressions or channels on the top surface of the lower lid; and
(iii) an access port for accessing said one or more compartments:
(b) an upper lid comprising:
(i) a tubular projection in the center, wherein the tubular projection of the upper lid is inserted into and attached to the tubular projection of the lower lid;
(ii) one or more raised ridges or teeth on the bottom surface of the upper lid; and
(iii) an access port for accessing said one or more compartments;
lining up the access port of the upper lid with the access port of the lower lid;
depressing the top of the upper lid of the child-resistant lid; and
rotating the lid clockwise or counter-clockwise until the access port is lined up with one or more of the compartments.

45. The method of claim 23, wherein the channels located or arrayed around the opening for the tubular projection on the top of the lower lid comprise one or more angled finger-like projections molded to the lower lid, and wherein depressing the top of the upper lid of the child-resistant lid causes the raised ridges of teeth on the bottom of the upper lid to flatten the angled finger-like projections, allowing for rotation of the lid.

46. The method of claim 23, the housing further comprising one or more raised ridges or teeth arranged around the inner circumference of the hollow or tunnel in the center of the housing, and
the lower lid further comprising one or more spring-like flaps comprising ridges or teeth, the one or more spring-like flaps being located in a hollow or void surrounding the tubular projection on the lower lid;
wherein the one or more spring-like flaps on the lower lid interlock with the one or more raised ridges or teeth arranged around the circumference of the hollow or tunnel in the center of the housing, preventing rotation of the lower lid when the child-resistant feature is engaged; and wherein the top of each spring-like flap on the lower lid further comprises a raised protrusion or tooth that aligns with one or more recesses, grooves, slots or depressions arranged around the tubular projection on the bottom of the upper lid when the access port on the upper lid is aligned with the access port on the lower lid;
depressing the top of the two-piece lid causes the one or more spring-like flaps on the lower lid to move below the one or more raised ridges or teeth arranged around the circumference of the hollow or tunnel in the center of the housing, allowing for rotation of the lid.

47. The method of any one of claims 23, 46 and 47, wherein depressing the top of the upper lid of the child-resistant lid causes the raised ridges or teeth on the lower lid to move below the raised ridges or teeth on the housing, allowing for rotation of the lid and accessing one of the compartments.

48. The method of claim 44, the housing further comprising one or more raised ridges or gear-like teeth arranged around the inner circumference of the body of the housing, and the lower lid further comprising one or more raised ridges or gear-like teeth around the circumference of the outer edge of the lower lid,
wherein the one or more raised ridges or gear-like teeth on the lower lid interlock with the one or more raised ridges or gear-like teeth on the body of the housing, preventing rotation of the lower lid when the child-resistant feature is engaged, and
depressing the top of the two-piece lid causes the one or more raised ridges or gear-like teeth on the lower lid to move below the one or more raised ridges or gear-like teeth on the body of the housing, allowing for rotation of the lid.

49. The method of claim 44, the housing further comprising one or more raised ridges or teeth arranged around the inner circumference of the tunnel in the center of the housing, and the lower lid further comprising one or more raised ridges or teeth arranged on the top side of the collar of the tubular projection on the lower lid,
wherein the one or more raised ridges or teeth on the top side of the collar of the tubular projection on the lower lid interlock with the one or more raised ridges or teeth on the inner circumference of the tunnel in the center of the housing, preventing rotation of the lower lid when the child-resistant feature is engaged, and
depressing the top of the two-piece lid causes the one or more raised ridges or teeth on the top side of the collar of the tubular projection on the lower lid to move below the one or more raised ridges or teeth on the inner circumference of the tunnel in the center of the housing, allowing for rotation of the lid.

50. A method of filling one or more compartments of the child-resistant container, the method comprising:
pouring a solid product onto a sticker or fill assister affixed to the center of the housing that covers the hollow or tunnel,
pushing or placing the proper amount of product into each said compartment,
removing the sticker or fill assister from the center of the housing,
assembling the two-piece child-resistant lid, and
attaching said lid to the housing.
